(19) United States
(12) Patent Application Publication
(10) Pub. No.: US 2024/0370942 A1
(43) Pub. Date: Nov. 7, 2024

(54) SYSTEM AND METHODS FOR NFT-GATED COMMUNITIES

(71) Applicant: Niche Protocol, Inc., Los Angeles, CA (US)

(72) Inventors: Zaven Nahapetyan, Brooklyn, NY (US); Christopher Paul Gulczynski, Los Angeles, CA (US); Sarah Kwajafa, Toronto (CA)

(21) Appl. No.: 18/142,983

(22) Filed: May 3, 2023

(51) Int. Cl. G06Q 50/00

(52) U.S. Cl. CPC G06Q 50/01

(57) ABSTRACT

In some embodiments, systems and methods provide, support, or implement an ecosystem for non-fungible token (NFT)-gated communities that are built and run by their members, as opposed to a social media platform provider. Each member of a community has or is assigned her/his/their own token, which grants access and rights to that member. The members, with their respective tokens, own and control their communities. Other embodiments are provided for generating or minting the tokens using, e.g., a neural network, and generating and transmitting one or more electronic invitations with hyperlinks to invite users to join an NFT-gated community as members.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### SUMMARY

This section summarizes some features of the invention of the present disclosure. Other features may be described in the subsequent sections. The invention is defined by the appended claims, which are incorporated into this section by reference.

In some embodiments, systems and methods provide, support, or implement an ecosystem for non-fungible token (NFT)-gated communities that are built and run by their members. Each member of a community has or is assigned her/his/their own token, which grants access and rights to that member. The members, with their respective tokens, own and control their communities.

Some embodiments provide systems and methods for a mobile application that is an ecosystem for non-fungible token (NFT)-gated communities.

Some embodiments provide systems and methods for readily and seamlessly creating a NFT-gated communities, e.g., through the push of a button on a feed.

Some embodiments provide systems and methods for receiving an NFT, e.g., for a gated community, through an invitation link.

Some embodiments provide systems and methods for programmatically generating NFT membership card designs from community photographs or images.

### BRIEF DESCRIPTION OF THE DRAWINGS

FIG. 1 illustrates an ecosystem for one or more non-fungible token (NFT)-gated communities, according to some embodiments.

FIG. 2 illustrates an example of a computer network which may support or implement at least some portions of the ecosystem of the present disclosure.

FIG. 3 illustrates an example of an implementation for a user device which may support or implement aspects of the present disclosure.

FIG. 4 illustrates an example of a blockchain, which can support or be used in connection with embodiments of the present disclosure.

FIG. 5 illustrates a peer-to-peer network of computers for supporting a blockchain.

FIG. 6 is a simplified diagram of a method for creating and managing a new NFT-gated community, according to some embodiments.

FIG. 7 is a simplified diagram of a method for generating a membership card for a community photograph or image, according to some embodiments.

FIG. 8 is a simplified diagram of a method for generating and/or receiving a non-fungible token through an invitation link, according to some embodiments.

FIGS. 9A through 9H show examples of a user interface illustrating member interaction with the on-line space of one or more communities, according to some embodiments.

FIG. 10 shows an example of a user interface for a digital wallet with membership cards, according to some embodiments.

FIGS. 11A through 11D illustrate the transformation of an image into a membership card, according to some embodiments.

FIGS. 12A and 12B illustrate examples of user interfaces with membership cards, according to some embodiments.

FIG. 13 illustrates an example of a user interface with an invitation link, according to some embodiments.

FIGS. 14A and 14B illustrate examples of user interfaces for no-code or low-code development, according to some embodiments.

### DETAILED DESCRIPTION OF SOME EMBODIMENTS

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent to one skilled in the art, however, that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The terminology used herein is for the purpose of describing particular embodiments only and is not intended to be limiting of the disclosed embodiments. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which disclosed embodiments belong. It will be further understood that terms such as those defined in commonly used dictionaries, should be interpreted as having a meaning that is consistent with their meaning in the context of the relevant art and will not be interpreted in an idealized or overly formal sense unless expressly so defined herein.

Social media has revolutionized the way that people connect, communicate, and interact. For example, using social media applications and platforms, artists, musicians, and other performers are able to reach their friends, fans, enthusiasts, etc. and develop even more of a following.

However, previously developed social media platforms and techniques can be problematic. Even though the users of social media create the content and generate the excitement, most social media platforms monetize the interactions of the users, for example, by selling advertising. The platforms, not the users, make the greatest profit.

Furthermore, previously developed social media platforms are centralized around the platforms. The platform provider controls the interactions of users, and defines and dictates the terms of service. Users of the platform are left to simply accept these terms, or otherwise not be allowed to participate.

According to embodiments of the present disclosure, systems and methods are provided that upend the traditional platforms. In some embodiments, the systems and methods provide, support, or implement an ecosystem for non-fungible token (NFT)-gated communities that are built and run by their members, as opposed to a social media platform provider. Each member of a community has or is assigned her/his/their own token, which grants access and rights to that member. The members, with their respective tokens, own and control their communities. Each community is separate, and may be its own decentralized autonomous organization (DAO).

In some embodiments, the members may interact or participate in their NFT-based communities using an application that may run or operate on a computer, such as a mobile device. In some embodiments, the mobile application may include or provide an active icon or “plus” button on an interface that allows a user to readily create a new club or community.

While a user may be a member of multiple communities, in some embodiments, a separate token or NFT is minted or provided to the user for each community. In some embodiments, the NFTs or tokens are provided through an invitation link. In some embodiments, each user may be provided with a digital wallet to keep the NFTs for each community to which the user belongs.

In some embodiments, a NFT membership card may be provided for each community. The design of the membership can be programmatically generated from photo or image selected or chosen by one or more members of the community.

In some embodiments, when creating a club, systems and methods of the present disclosure provide an option to add in photos and generate the NFT membership card design algorithmically and/or through neural networks.

In some embodiments the tokens or NFTs exist on a blockchain, supported by or operating under the NEAR blockchain protocol.

### Technology and Implementation

As will be appreciated by one skilled in the art, embodiments of the present invention can be embodied or implemented as a method, system, and/or a processor-readable medium. Accordingly, the embodiments may take the form of an entire hardware application, an entire software embodiment or an embodiment combining software and hardware aspects all generally referred to herein as a “circuit” or “module.” Furthermore, the embodiments may take the form of a computer program product on a computer-usable storage medium having computer-usable program code embodied in the medium. Any suitable computer-readable medium or processor-readable medium may be utilized including, for example, but not limited to, hard disks, USB Flash Drives, DVDs, CD-ROMs, optical storage devices, magnetic storage devices, etc.

Computer program code for carrying out operations of the disclosed embodiments may be written in an object oriented programming language (e.g., Java, C++, etc.). The computer program code, however, for carrying out operations of the disclosed embodiments may also be written in conventional procedural programming languages such as the “C” programming language, HTML, XML, etc., or in a visually oriented programming environment such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.XX, and cellular network or the connection may be made to an external computer via most third-party supported networks (for example, through the Internet using an Internet Service Provider).

The disclosed embodiments are described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Note that the instructions described herein such as, for example, the operations/instructions and steps discussed herein, and any other processes described herein can be implemented in the context of hardware and/or software. In the context of software, such operations/instructions of the methods described herein can be implemented as, for example, computer-executable instructions such as program modules being executed by a single computer or a group of computers or other processors and processing devices. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, tablet computers, remote control devices, wireless hand held devices, smartphones, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc. Additionally, the term “module” can also refer in some instances to a hardware component such as a computer chip or other hardware.

It will be understood that the circuits and other means supported by each block and combinations of blocks can be implemented by special purpose hardware, software or firmware operating on special or general-purpose data processors, or combinations thereof. It should also be noted that, in some alternative implementations, the operations noted in the blocks may occur out of the order noted in the figures. For example, two blocks shown in succession may in fact be executed substantially concurrently, or the blocks may sometimes be executed in the reverse order, or the varying embodiments described herein can be combined with one another or portions of such embodiments can be combined with portions of other embodiments in another embodiment.

### Ecosystem for Non-Fungible Token (NFT)-Gated Communities or Clubs

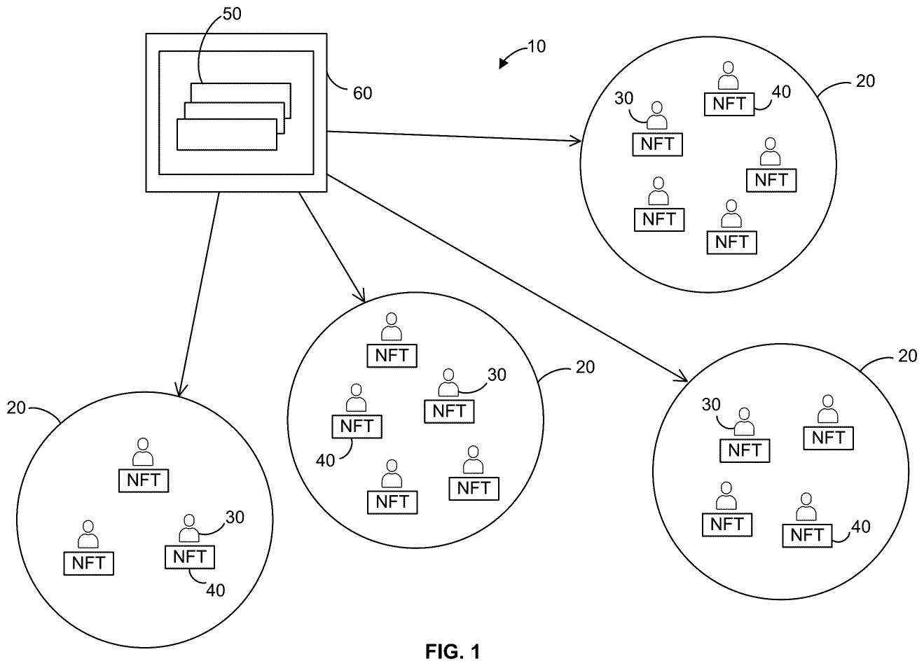

FIG. 1 illustrates an environment in which systems and methods of the present disclosure can operate. FIG. 1 shows an example of an ecosystem 10 for one or more non-fungible token (NFT)-gated communities or clubs 20, according to embodiments of the present disclosure. Ecosystem 10 can be an on-line space for various musicians, artists, creators, clubs, teams, hobbyists, non-profits, small businesses, etc. organized according to common interests or niches.

Each community 20 in ecosystem 10 comprises or is made up of a plurality of members 30. The members 30 in a community 20 share a common interest or niche: for example, in a particular artist, musician, performer, influencer, or band; a particular activity (e.g., running, fencing, rock climbing, adventure travel, cooking, computer gaming, growing plants, collecting memorabilia); a particular team or a club (e.g., a local scout troop, little league baseball team, rowing club, or automobile club); or any other interest. In some embodiments, each member 30 can be an individual, user, or other entity. But no entity or individual who is a member of one community 20 in ecosystem 10 is necessarily precluded from joining or being a member of another community 20. That is, any individual or user can be a member of multiple communities 20 in ecosystem 10, depending on, among other things, her/his/their interests.

According to some embodiments, each community 20 is organized, owned, and controlled by the members 30 making up that community 20. For example, the members 30 of a community 20 decide who to invite and who can join the community. Likewise, one or more members 30 of the community create and share content with other members 30 in the community.

In one non-limiting example, a user of ecosystem 10 can be an independent artist or musician, with a devoted group of followers, each of whom could also be users. The musician can create a community 20 for her fans. The members 30 of the community 20 can include both the musician and the fans. The token- or currency-gated community 20 allows an artist to connect with her audience. The musician and the fans can generate content, such as recordings of songs, videos of concerts, etc. The musician and the fans may decide that membership to the community will be on a subscription basis, so that each member pays a fee to belong to the community. This allows the musician to realize value or make money from her/his/their work or content, and the fans to support the musician. With ecosystem 10 and its communities 20, musicians can readily mint and sell music, raise money for tours and production, sell tickets to live performances, and take ownership of the distribution, all without sacrificing or giving up rights to their content.

As another non-limiting example, one or more users of ecosystem 10 can be members of a sports club or team, such as a club rowing team at a university or college. The community 20 of members 30 for this team can includes past and present members of the club rowing team, their friends, family, etc. In many cases, such club sports teams receive little to no funding from the university or college, and thus must generate or come up with their own funds to keep the team going, e.g., by buying and maintaining equipment, pay for travel expenses for games, tournaments, regattas, etc. The community 20 allows the members to share their interest, build comraderie, raise the team's profile, and raise funds to support the activity. The token- or currency-gated community 20 provides or supports a digital space for real-life clubs to make planning, communicating, and scheduling events easier than before.

In yet another example, a community 20 can be created for, or related to or associated with a small business, such as a local bakery. The community 20 allows the small business to connect with its real-life customers, promote its products, and educate members 30 on what matters to the industry (e.g., organic ingredients), without the feeling of being forced to join any pointless trends in the hopes of going viral.

In ecosystem 10, each community 20 may have its own respective on-line or virtual space within which members 30 of that community 20 may interact, for example, by sharing photographs, images, videos, audio recordings, comments, texts, messages, posts, allow for discussion, raise funds, solicit donations, etc. In some embodiments, one user or member 30 can have a private on-line discussion with another member by exchanging messages. In some embodiments, a member 30 can create or generate a post that is shared or can be seen by all other members; the community members may discuss the post, for example, by providing or entering comments.

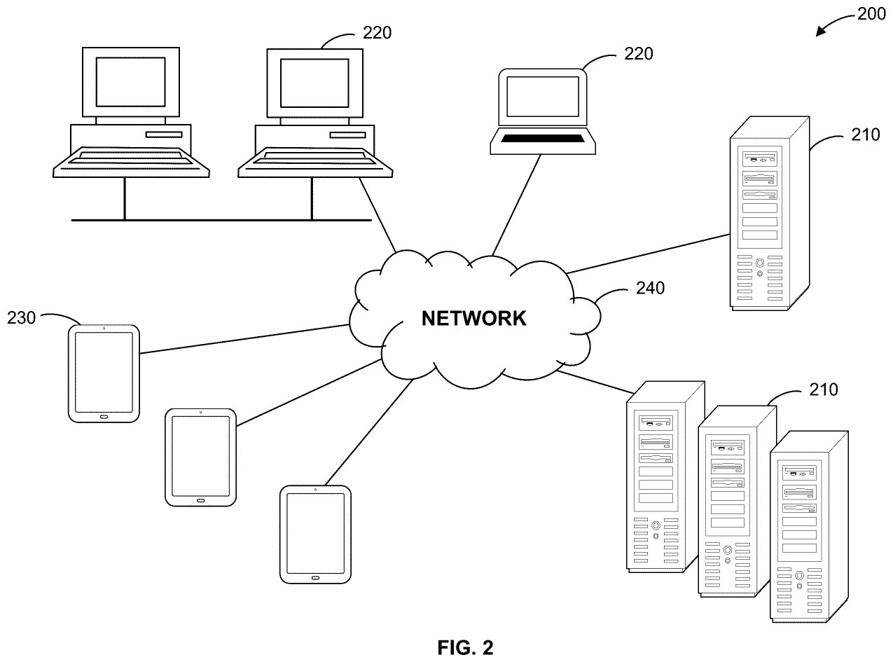

The on-line or virtual space for each community 20 may be implemented, supported, or provided by computer database systems and networks, as further described with respect to FIG. 2. A user or individual who is a member of one or more communities 20 of ecosystem 10 can access the respective on-line or virtual space for such communities 20 through one or more applications 50 running on a user system or device 60.

Application 50 can comprise computer software, instructions, or code installed and running on the user device 60. In some embodiments, such software application 50 can be downloaded onto a network-enabled device 60 to perform the functions described herein. The entire program code, or portions thereof, for application 50 may be stored in any volatile or non-volatile memory medium or device as is well known, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium (e.g., over the Internet and/or from another server, as is well known) and/or transmitted over any other conventional network connection as is well known (e.g., extranet, virtual private network (VPN), LAN, and/or the like) using any communication medium and/or protocols (e.g., TCP/IP, HTTP, HTTPS, Ethernet, and/or the like) as are well known. It will also be appreciated that computer code for implementing embodiments of application 50 may be implemented in any programming language that is executable on a computing system, such as, for example, C, C++, HTML, any other markup language, Java™, JavaScript, ActiveX, any other scripting language (e.g., VBScript), and/or many other programming languages as are well known may be used. (Java™ is a trademark of Sun MicroSystems, Inc.).

User device 60 can be a desktop personal computer, workstation, laptop, notepad computer, personal digital assistant (PDA), cell phone, or any wireless access protocol (WAP) enabled device or any other suitable computing device capable of interfacing directly or indirectly to the Internet or other network connection.

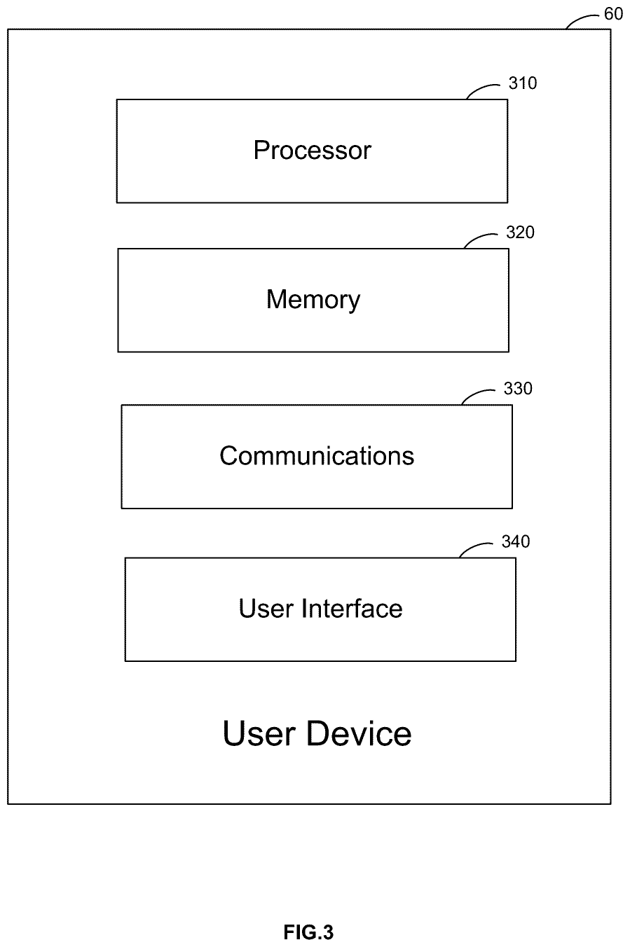

As shown in FIG. 3, in some embodiments, user device 60 includes one or more computer processors 310 coupled to computer storage or memory 320, communication equipment 330, and user interface 340.

Operation of user device 60 is controlled by processor 310, which may be implemented as one or more central processing units, multi-core processors, microprocessors, microcontrollers, digital signal processors, field programmable gate arrays (FPGAs), application specific integrated circuits (ASICs), graphics processing units (GPUs), tensor processing units (TPUs), and/or the like in user device 60.

Memory 320 may be used to store software, including, for example, application 50, executed by user device 60 and/or one or more data structures used during operation of user device 60. Memory 320 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read. In some embodiments, memory 320 provides or implements a non-transitory computer readable memory, which has stored thereon instructions executable by the user device 60 to cause the user device 60 to perform functions.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities. In some examples, memory 320 may include non-transitory, tangible, machine readable media that includes executable code that when run by one or more processors (e.g., processor 310) may cause the user device 60, alone or in conjunction with other computing devices supporting ecosystem 10, to perform any of the methods described further herein.

Communication equipment 330 supports communication by user device 60 with other computer networks and services over any suitable communications medium, e.g., wireless (radio) or wired (line). In some embodiments, communication equipment 330 include a Direct Short Range Communications (DSRC) radio and non-DSRC radio equipment such as a mobile phone.

In some embodiments, user device 60 runs an HTTP client (e.g., a browsing program, such as Microsoft's Internet Explorer browser, Netscape's Navigator browser, Google's Chrome browser, Opera's browser, a WAP-enabled browser in the case of a cell phone, notepad computer, PDA or other wireless device, and/or the like). Embodiments of the user device 60 are suitable for use with the Internet, which refers to a specific global internetwork of networks. However, it should be understood that other networks can be used instead of the Internet, such as an intranet, an extranet, a virtual private network (VPN), a non-TCP/IP based network, any local area network (LAN) or wide area network (WAN), and/or the like.

User interface 340 may comprise one or more user interface devices (e.g., a keyboard, a mouse, trackball, touch pad, touch screen, pen, and/or the like) for interacting with a graphical user interface (GUI) provided by the browser on a display (e.g., a monitor screen, liquid crystal display (LCD) monitor, light emitting diode (LED) monitor, organic light emitting diode (OLED) monitor, and/or the like) in conjunction with pages, forms, applications, and/or other information provided by database system and/or other systems and/or servers.

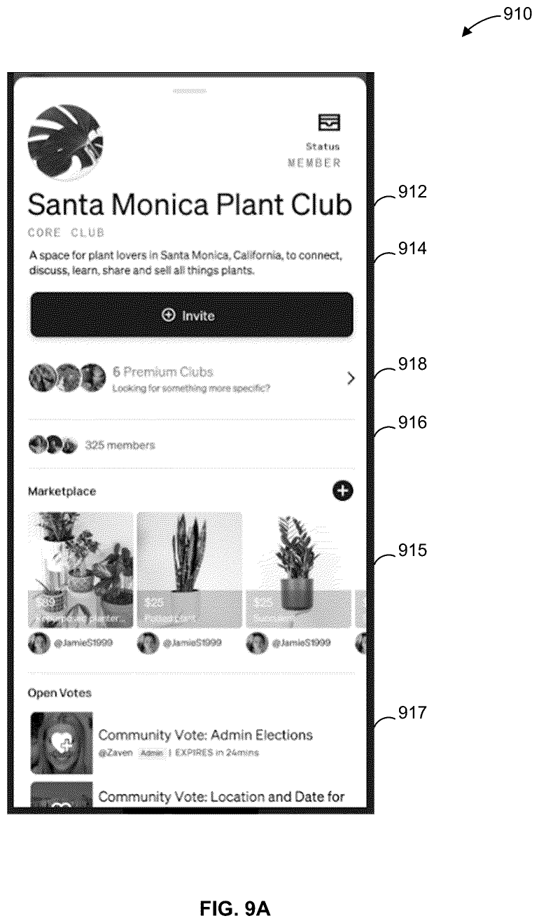

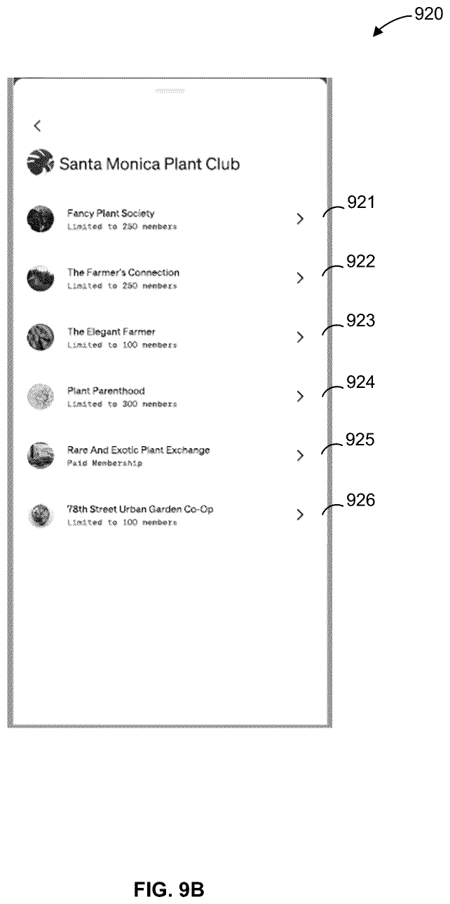

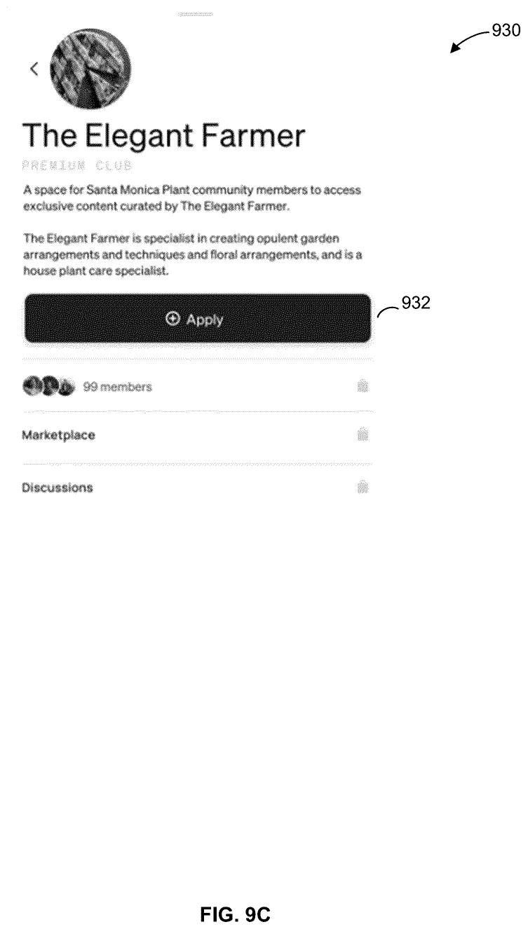

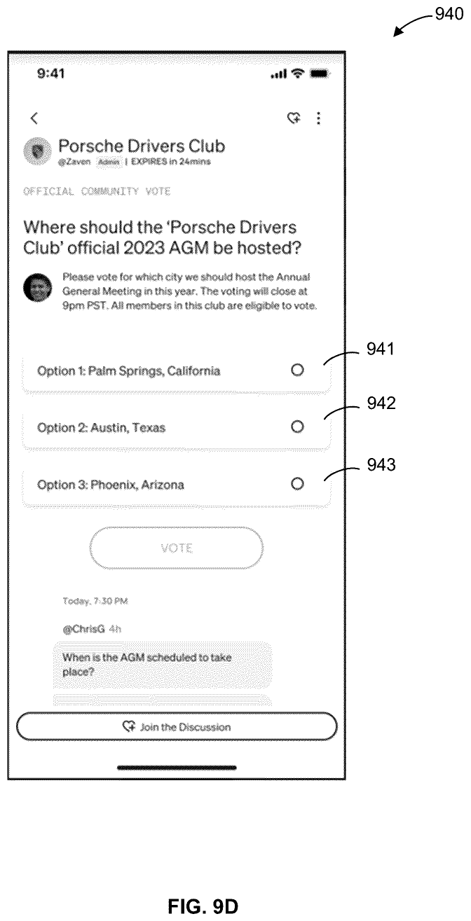

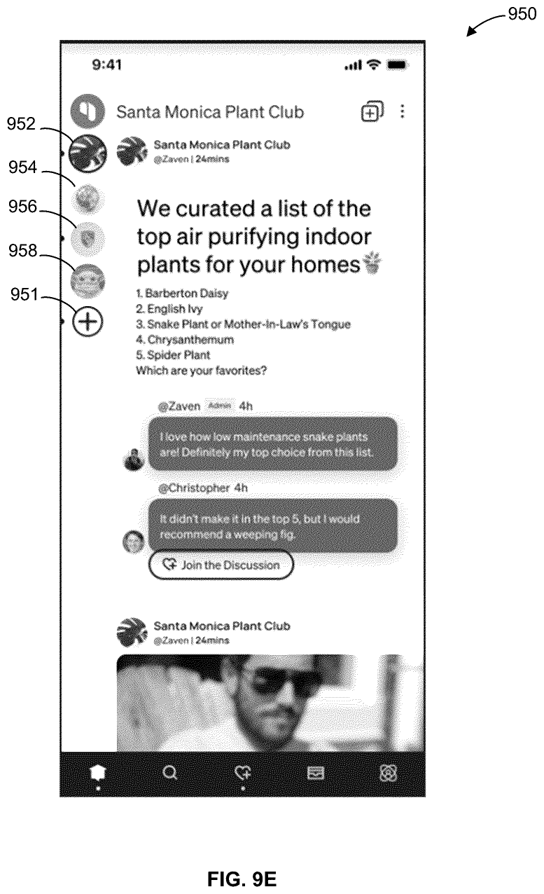

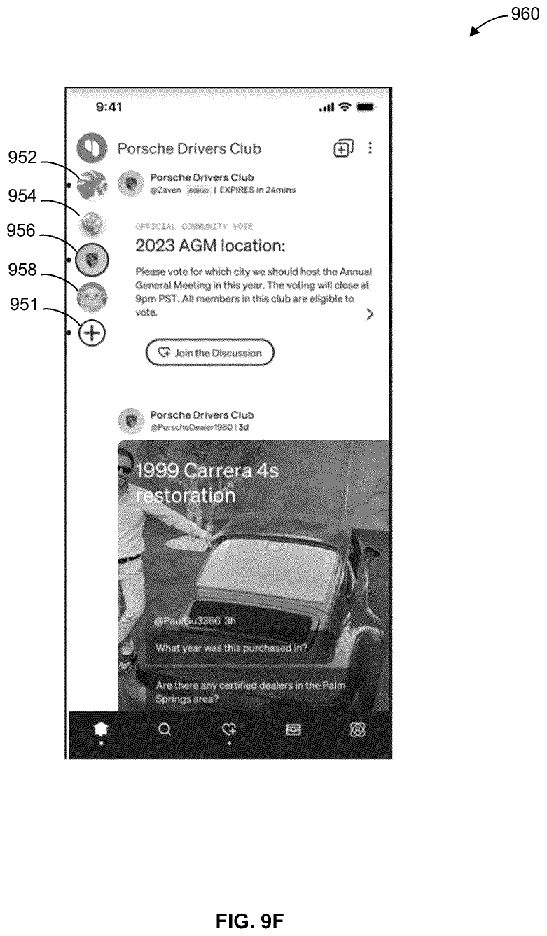

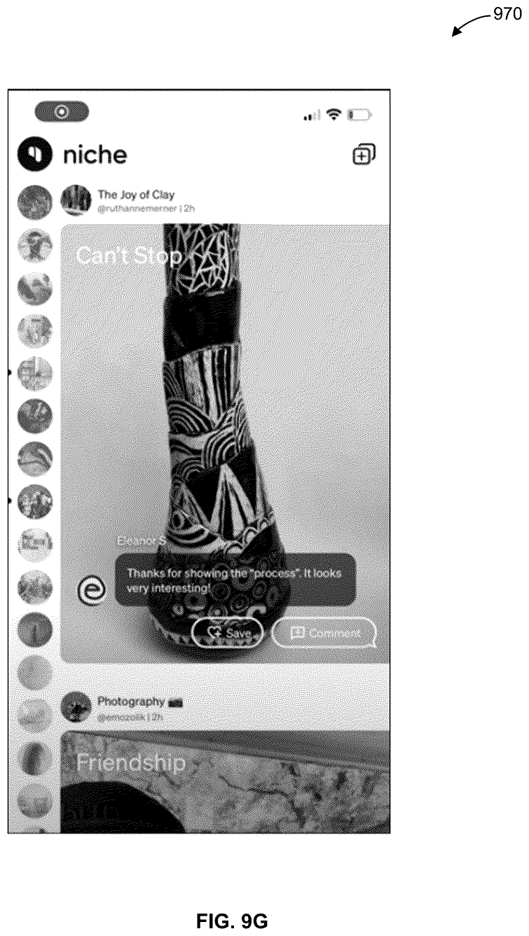

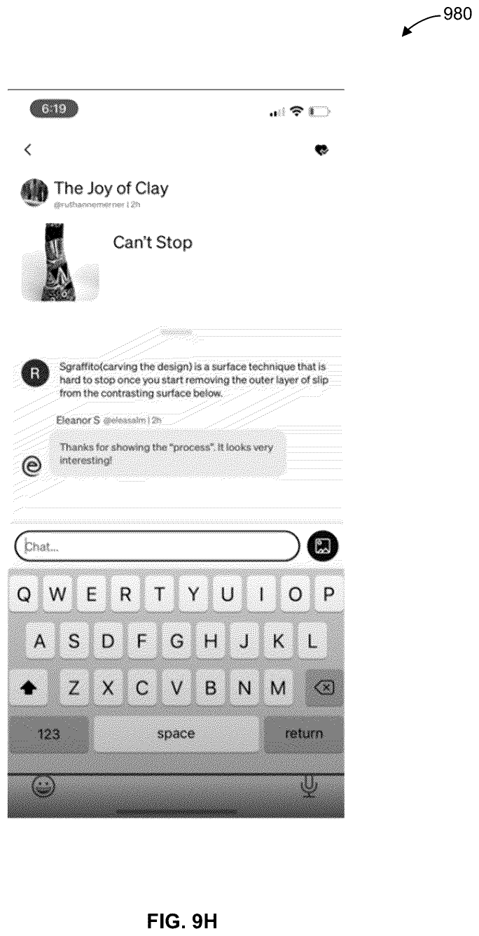

Referring again to FIG. 1, user device 60 running application 50 allows a user to participate as a member 30 of one or more of communities 20 in ecosystem 10, for example, by accessing, processing, downloading, viewing, uploading and/or providing information, pages, and/or applications supported or stored on the database systems supporting the on-line or virtual spaces for such communities 20. In the on-line spaces of a community 20, members 30 of the community may share images, photographs, videos, audio recording, ideas, tips, and engage in general discussion. The members 30 can also handle or address administrative or housekeeping items for the community, like voting on officers or actions, or to pay dues. Members 30 of a community 20 may use the community's on-line space to plan for events (e.g., the next tournament, game, regatta, hike, etc.), for fundraising, and the like. Examples of user or member 30 interactions with the on-line space of various communities are illustrated and described below with reference to FIGS. 9A-9F.

In some embodiments, access to the on-line or virtual space of a community 20 can be restricted or controlled by the use of non-fungible tokens (NFTs) 40. A non-fungible token 40 can be a unique cryptographic token which cannot be replicated. The non-fungible tokens 40 support or provide gating to communities 20 of ecosystem 10.

In some embodiments, each member 30 of a community 20 can be assigned, granted, or associated with her/his/their own unique non-fungible token 40 for that community. Each non-fungible token 40 is a digital asset, similar to cryptocurrency, and can be owned by only one person at a time. Unlike cryptocurrency tokens, which are fungible with many of the same token existing, non-fungible tokens are limited to a supply of one unique digital token. The non-fungible tokens 40 exist on a blockchain, which can be used as or to support a digital ledger for ensuring the immutability and reliability of transactions involving the tokens. In some embodiments, a single blockchain may be created for all of the non-fungible tokens 40 used in connection with ecosystem 10. In some embodiments, multiple blockchains may be created for the non-fungible tokens 40 of the ecosystem 10 with, for example, a separate blockchain provided for each community 20.

In some embodiments of the present disclosure, the non-fungible tokens 40 are created or administered by an administrator or operator of ecosystem 10 using the networks, computers, servers, modules, applications, processes, etc. of the present disclosure. Such administrator or operator manages the ecosystem 10 and may handle or take care of various administrative tasks for the ecosystem 10 and the related communities 20, including, for example, providing, supporting, or contracting for the computer resources (e.g., hardware and software) for hosting the on-line or virtual spaces for the communities 20, adding newly minted tokens 40 to the blockchain, developing and updating the application 50, etc.

In some embodiments, non-fungible tokens 40 are created or “minted,” and their ownership assigned, using smart contracts. Smart contracts are computer code capable of automatically executing actions based on if/then statements. At a basic level, smart contracts act as a tool to implement some kind of agreement associated with the token. Smart contracts ensure that the non-fungible tokens 40 cannot be divided and that the digital assets are one of a kind and non-replicable. Smart contracts may be incorporated or embedded in the blockchain for non-fungible tokens 40.

When a new non-fungible token 40 is minted, the smart contract automatically sets the creator, which can be the administrator or operator for ecosystem 10, as the owner. After that, smart contracts can transfer the non-fungible tokens 40 to new owners, such as various users, when such users agree to join as members 30 of a community 20.

In some embodiments, the application 50 uses non-fungible tokens 40 specifically to maintain membership within decentralized communities. A non-fungible token 40 can function to represent a user or member 30's identity, property rights, privileges, etc. for the community 20. In some embodiments, non-fungible tokens 40 are represented, e.g., on a user interface associated with the application 50, through algorithmically generated images that resemble a uniquely editioned “membership card.” In some embodiments, when creating a club, the application provides an option to add in photos and generate the NFT membership card design algorithmically and/or through neural networks.

A user or individual must have a non-fungible token 40 to establish that she/he/they is a member 30 of a community 20, thereby being granted access to the respective on-line or virtual space of the community. Holders of these tokens 40—i.e., users who are members 30 of a community—may engage in governance of such community 20, such as electing new moderators or removing content that violates their community's guidelines. This governance and control of the community 20 by members 30 can be implemented or provided through smart contracts living on the blockchain that execute decisions automatically, for example, based on voting by token holders.

In some embodiments, communities 20 of ecosystem 10 are decentralized, leveraging peer-to-peer technologies such as layer one blockchains to maintain membership information. As such, membership for each community 20 can be verified in a trust-less, distributed, and permanent way that cannot be tampered with by a third-party, such as the administrator or operator of ecosystem 10.

This means that, in some embodiments, each community 20 in ecosystem 10 can be a decentralized autonomous organization (DAO). A decentralized autonomous organization is a structure that has no central governing body and whose members 30 share a common goal to act in the best interest of the organization. Such decentralized autonomous organization structure allows the communities 20 of ecosystem 10 to make decisions in a bottoms-up management approach. Members 30 of the decentralized autonomous organization (or community 20) own the non-fungible tokens 40 of the organization, and members can vote on initiatives for the organization. In some embodiments, smart contracts are implemented for the decentralized autonomous organization or community 20, and the code governing the organization or community's operations is publicly disclosed.

Because they are decentralized, communities 20 of ecosystem 10 are different from other types of in-person or online communities. For example, communities organized online through other social networking platforms can be (and often are) shut down by such platforms for alleged violations of the platforms' policies without due process or the ability for appeal. On the other hand, a decentralized community, like any one or more of the communities 20 of ecosystem 10, is managed through membership that is maintained using blockchain or distributed ledger technology, where members hold non-fungible tokens 40 representing participation and ownership in this community. The distributed ledger prevents a single centralized service (such as a typical social networking platform provider) from removing members 30 or shutting down the community 20. Furthermore, the distributed ledger gives the token owners the power to move from one platform to another at their will.

While embodiments of the present disclosure utilize and bring together the concepts and techniques for non-fungible tokens 40, blockchain, smart contracts, decentralized autonomous organizations (DAOs), on-line spaces, etc., the services and implementation for the same are not necessarily related. That is, one platform or provider may support the creation of non-fungible tokens and blockchain, another platform or provider may support the distribution of non-fungible tokens, yet another platform or provider supports or hosts the on-line or virtual spaces for a community, still another platform or provider may support DAOs, and yet another supports governing a community as a DAO. According to some embodiments, as described below in more detail, systems and methods of the present disclosure simplify the creation and provisioning of the NFT-gated communities 20 on behalf of members 30.

In contrast to previously developed systems, ecosystem 10 reorganizes social networks into interest-based clubs or communities 20 that are owned by its members 30. With a token and/or currency-based economy, the user or members 30 own the community 20 and its content. The clubs or communities 20 in ecosystem 10 are exclusive, as membership is by invitation only and access is granted through the non-fungible tokens 40. The members 30 of each community 20, not a service provider or social network platform, control how the community is run. Members 30, for example, may decide to make their community 20 a private or exclusive club, where the virtual or on-line space of the community is only accessible or viewable by users holding the requisite non-fungible tokens 40 for the club. Alternately, the members 30 may decide to make some aspects of their community 20 public, such as, for example, allowing non-members (who do not possess a non-fungible token 40), to view (but not make) posts or comments in the community.

In some embodiments, systems and methods of the present disclosure provide for or support transactions and interactions within or between one or more communities 20 of the ecosystem. For example, in the community 20 an artist or musician can sell recordings of her music directly to her fans, either with tokens (e.g., BitCoin) or currency (e.g., US dollars). A musician may also sell tickets or access to live performances through the community 20, with the members having priority over non-members. As another example, contributors or benefactors a club sports team or non-profit organization associated with a community 20 are able make contributions or donations directly to the respective community through, e.g., the application 50. The club or community 20 can sell tickets to live events (e.g., a game, race, fundraiser, etc.). Members 30 of a community may vote on action items, such as the date and location of the next in-person event, the election of new officers, or changes to the rules, procedures, by-laws of the community 20.

Ecosystem 10 makes it easier for independent artists, creators, musicians, bands, content producers, influencers, personalities, clubs, teams, hobbyists, non-profits, interest groups, small businesses, etc. to succeed against established brands on typical social media platforms.

For example, previously developed platforms are able to sell more advertising for an artist or content producer who has grown a following and increased engagement with her/his/their fans. Such platforms turn the artist's value and passion into profits for themselves. By contrast, in ecosystem 10—with its token—and/or currency-based economy and communities 20—artists, content producers, etc. have direct access to their most engaged fans. The artists, creators own the content; they own the network; they own the profits. Ecosystem 10 and the token- and/or currency-based communities 20 return the revenue and profits back to the artist and creators. Communities 20 allow creators, bands, clubs, teams, hobbyists, small businesses, and other groups to build value for themselves. The members 30 decide how their community 20 is run.

Previously developed social media platforms give artists or content producers an audience for their content. Fans and followers consume the content, and in some instances may be able to make short comments. But they are mostly passive, and do not engage with one another. In contrast, ecosystem 10 and the token- and/or currency-based communities 20 allow artists and content producers to build community around their content. The artists and content producers are not just selling to an audience. They are making a community in their distribution network.

Member Interaction with NFT-Gated Communities or Clubs

FIGS. 9A through 9F show screenshots for examples of interaction by a user with ecosystem 10 and its communities 20 in the respective on-line spaces.

FIG. 9A is screen shot 910 for an opening or “cover” page for the on-line space of an example community 20. As shown, the cover page gives the name 912 of the community (e.g., the Santa Monica Plant Club), a brief description 914 of the community's interest or niche, and the current number 916 of members. The cover page for one community may also provide an active element 918 (e.g., icon or button) for other communities with similar or related interests. If the user “clicks” on the active element 912, the application 50 will present more information about the other communities, as shown in FIG. 9B.

FIG. 9B is a screenshot 920 where a user who is a member 20 of the Santa Monica Plant Club may be presented with information about other communities: the Fancy Plant Society, the Farmer's Connection, The Elegant Farmer, Plant Parenthood, Rare and Exotic Plant Exchange, and 78^{th} Street Urban Garden Co-op. A respective active element (e.g., icon or button) 921, 922, 923, 924, 925, 926 is provided each of the other communities. If the user clicks on the active element for one of the other communities (e.g., The Elegant Farmer), the user is taken to an application page 930 for the selected community, as shown in FIG. 9C, where the user may then apply for membership, for example, by clicking on an “apply” icon 932.

With reference again to FIG. 9A, the “cover” page for a community's on-line space may also show marketplace items for the community, as well as administrative or housekeeping items (e.g., voting). These items may be represented with active elements 915, 917, which the user can use to, for example, to purchase a good or cast a vote.

FIG. 9D is a screenshot 940 of an example voting page for a community, e.g., the Porsche Drivers Club. In this example, the question presented for voting relates to where the next annual general meeting of the club or community should be held. The application 50 provides a number of options, e.g.: Option 1-Palm Springs, California; Option 2-Austin, Texas; and Option 3-Phoenix, Arizona. Each option can be represented with a respective active element 941, 942, 943. Some or all of the members 30 of the community 20 can cast a vote to select from one of the several options. In some embodiments, the systems and methods of the present disclosure generate and execute smart contracts to implement the voting process—e.g., who may vote, the time period for voting, the number or percentage of votes necessary for any option to be declared the winner, etc.

Further in the on-line space for a community 20, members 30 can engage in discussions, share tips and information, provide or view how-to sessions, etc. based on shared interests. Members 30 may also add links, e.g., to products, websites, relevant to the interests.

In some embodiments, a user who is a member of multiple communities 20 may be provided with the ability to easily switch between the communities, as shown in FIGS. 9E and 9F. FIG. 9E is a screenshot 950 for a feed associated with one community (e.g., the Santa Monica Plant Club), where icons 952, 954, 956, and 958 are provided for some of the communities 20 to which the viewing user is a member 30. From the feed for the current community, the user can move to the on-line space for another community (e.g., Porsche Drivers Club) by clicking on icon 956. The user is then taken to the feed for the selected community, as seen in the example screenshot 960 of FIG. 9F. That feed for the second community similarly includes the same icons 952, 954, 956, and 958 for all or a portion of the communities 20 to which the user is a member 20.

According to some embodiments, systems and methods of the present disclosure further foster or build community among members 30 by facilitating or supporting the ready transition of member interactions from the on-line space to the real-world. Because the systems mint a unique token or NFT for each member 30 of a community 20, the members can use their respective tokens as a pass to gain access to a live event for the community. For example, for a community 20 relating to a particular artist or musician, the token can be used as a ticket for live performances or concerts by such artist. In other examples, members belonging to clubs or communities relating to a particular hobby, sport, or interest can use their tokens to access a club facility, e.g., rock climbing gym, art or photography studio, plant nursery or greenhouse, commercial kitchen, auto garage, archery range, dock, boathouse, etc., where they can meet up, interact, and engage in person.

### Computing Network for Implementing or Supporting the Ecosystem

Ecosystem 10 for one or more non-fungible token (NFT)-gated communities 20 is supported or implemented with computer hardware and software which together execute the necessary processes, algorithms, instructions, modules, and/or operations for ecosystem 10. These operations and processes include, for example, creating the on-line or virtual space for each community 20, creating a decentralized autonomous organization (DAO) for a community 20, generating non-fungible tokens 40 for use by members 30 of the communities 10, distributing the tokens 40 (e.g., by invitation to potential members), administering the communities 20 (e.g., by checking tokens 40, hosting the on-line or virtual space, adding, storing, deleting, or removing content, executing smart contracts, administering voting and elections, admitting new members and removing existing members, maintaining or ensuring compliance with policies and processes), etc.

FIG. 2 is a block diagram of an exemplary networked computing environment 200 suitable for supporting or implementing at least some portions or aspects of the ecosystem 10 of the present disclosure. As shown, the exemplary networked computing environment 200 includes servers 210, user computers 220 (e.g., desktop or laptop), and mobile devices 230. It should be understood, however, that the exemplary networked environment 200 is for illustration purposes only, and should not be construed as limiting upon the present disclosure. Those skilled in the art will recognize that any number of servers, user computers, mobile devices, or other computing devices, may be present in an actual embodiment.

Servers 210 can include application and/or database servers configured to implement and execute software applications as well as provide related data, code, forms, webpages and other information to and from user computers 220 and mobile devices 230 and to store to, and retrieve from, a database system related data, objects, and web page content.

User computers 220 and mobile devices 230 are examples of computing devices that can be used by a user, for example, to process or store information, or communicate or interact in networked computing environment 200. In general, any such user device can include a desktop personal computer, workstation, laptop, notepad computer, PDA, cell phone, or any wireless access protocol (WAP) enabled device or any other computing device capable of interfacing directly or indirectly to the Internet or other network connection, such as already described with reference to FIG. 3. Each of user devices (e.g., user computers 220 and mobile devices 230) may run an HTTP client (e.g., a browsing program and/or the like) allowing a user (e.g., a member 30 of a community 20) to download, access, process, view, upload, and/or store information, pages, and/or applications, etc. for the community 20.

According to some embodiments, servers 210, user computers 220, and/or mobile devices 230 provide or implement the processing and storage capabilities and functionalities for creating, maintaining, running, and supporting the communities 20 of ecosystem 10.

For example, servers 210, user computers 220, and/or mobile devices 230 may execute one or more applications or processes for creating the on-line or virtual spaces for communities 20, creating a decentralized autonomous organization (DAO) for a community 20, generating non-fungible tokens 40 for use by community members 30, generating memberships card designs, creating and populating a virtual wallet with tokens 40, distributing the tokens 40, checking tokens 40 of members 30 before granting access to a community 20, processing or executing financial transactions (currency or token-based), etc. It will also be appreciated that computer code for implementing embodiments of the present disclosure may be implemented in any programming language that is executable on a client system and/or server or server system such as, for example, C, C++, HTML, any other markup language, Java™, JavaScript, ActiveX, any other scripting language (e.g., VBScript), and/or many other programming languages as are well known may be used. (Java™ is a trademark of Sun MicroSystems, Inc.). In some embodiments, servers 210 and/or user computers 220 may include an application platform that enables creating, managing, and/or executing the one or more applications of the present disclosure.

Content and other information for one or more communities 20 of ecosystem 10 can be stored in one or more of servers 210, user computers 220, and mobile devices 230 in the networked computing environment 200. For each community 20, this content and other information may include, for example, the name of the community 20, the purpose or description of the community, rules, regulations, by-laws of the community, the names or other identifiers of the founding members, the names or other identifiers of the current and past members, the status of each member (e.g., active, inactive, former, invited), contact information for members, membership dues or subscription fees for the community or its on-line space, the names or other identifiers officers or administrators for the community, NFT or token information, membership card information, discussions and messages shared or viewable by all or some members of the community, images, audio and/or video files uploaded by one or more members, information regarding whether the community is private or public, etc. Any portion of content for a community 20 may be hosted on a single server or computer, mirrored, or replicated on multiple servers or computers, or distributed throughout the computer network. One or more servers 210 may function or operate as a web server to distribute content and information for the communities 20 and host the related on-line or virtual spaces.

In some embodiments, all or a portion of the content and information for a community 20 is available to all or only some of the community members depending on privileges, access rights, and/or how the community 20 is set up or later modified by the members.

In some embodiments, servers 210, user computers 220, and mobile devices 230 store and maintain one or more forms, code, or modules for smart contracts. Such smart contracts implement actions, transactions, administration, governance, and the like in connection with the activity of members 30 in their communities 20. For example, a smart contract can implement gate-keeping for the community, checking whether users have the appropriate token 40 for a club and allowing or granting only those users with the appropriate tokens access to the on-line or virtual space or the community 20. As another example, a smart contract can implement or execute a purchase of a product or service by one member 30 from another-such as a fan member buying the latest song track from an artist member. As yet another example, a smart contract can implement voting or elections for the community, such as the members 30 voting on new officers or the location of the next in-person meeting. Thus, for example, a smart contract may support or implement the election of new officers by majority vote based on a specified quorum of members, such that when the members have finished casting their votes, the smart contract will present or support a user interface with an announcement of the winners of the election. One or more smart contracts can also implement or execute the adding of new members, the deletion or removal of existing members, the deletion or removal of text, comments, discussion, images, audio or video content based on member or community preferences, etc. Systems and methods of the present disclosure identify, select, modify, complete forms or modules for smart contracts based on parameters input or determined from users. In some embodiments, the smart contract forms and modules are maintained in one or more libraries at the servers and computers.

Computer code for programs and applications, and content and information for the communities 20 of ecosystem 10 may be downloaded and stored in any suitable volatile or non-volatile memory medium or device in database servers 210, user computers 220, and/or mobile devices 230, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, for any application for the present disclosure may be transmitted and downloaded from a software source over a transmission medium (e.g., over the Internet and/or from another server, as is well known) and/or transmitted over any other conventional network connection as is well known (e.g., extranet, virtual private network (VPN), LAN, and/or the like) using any communication medium and/or protocols (e.g., TCP/IP, HTTP, HTTPS, Ethernet, and/or the like) as are well known.

As illustrated in FIG. 2, database servers 210, user computers 220 (e.g., desktop or laptop), and mobile devices 230 are connected via a communications network 240. Network 240 is a communicative platform operable to exchange data or information between database servers 210, user computers 220, mobile devices 230, and any other computer systems that may be connected to the network. Communications network 240 is any network or combination of networks of devices that communicate with one another. For example, network 240 may be any one or any combination of one or more local area networks (LANs), one or more wide area networks (WANs), one or more telephone networks, one or more wireless networks, one or more point-to-point networks, one or more star networks, one or more token ring networks, one or more hub networks, and/or other appropriate configuration. As the most common type of computer network in current use is a transfer control protocol and Internet protocol (TCP/IP) network, such as the global inter network of networks often referred to as the “Internet” with a capital “I” that network will be used in many of the examples herein. However, it should be understood that network 240 is not so limited and other network protocols may be supported.

Servers 210, user computers 220 (e.g., desktop or laptop), and mobile devices 230 may communicate using TCP/IP and, at a higher network level, use other common Internet protocols to communicate, such as one or more of hypertext transfer protocol (HTTP), file transfer protocol (FTP), Andrew file system (AFS), wireless application protocol (WAP), and/or the like. In some examples where HTTP is used, user devices (e.g., user computers 220 and mobile devices 230) may include an HTTP client commonly referred to as a “browser” for sending and receiving HTTP messages to and from an HTTP server, as may be implemented on a server 210.

### Blockchain and Peer-to-Peer Network for the Ecosystem

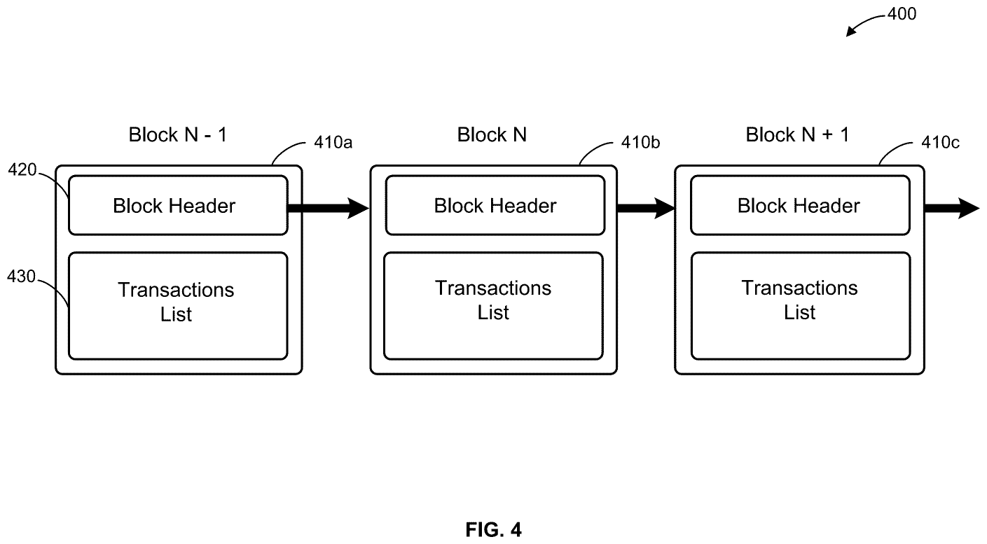

According to some embodiments, each community 20 in ecosystem 10 can be gated through the use of non-fungible tokens 40 existing on a blockchain. FIG. 4 illustrates a blockchain 400 which can be used as or to support a digital ledger for ensuring the immutability and reliability of transactions involving the non-fungible tokens 40 used in ecosystem 10. In some embodiments, blockchain 400 further supports or maintains smart contracts, content, accounts, and/or other data and information for one or more communities 20 in ecosystem 10.

Blockchain 400 can be viewed as a chain or sequence of data blocks 410a-b. Each block 410 may comprise information or data for a list of transactions connected to the previous block 410 in the chain 400, also called a “parent” block. Each block 410, including the crucial link to the previous block, is secured by layers of encryption. In some examples, a block 410 is a container-type content or data structure that aggregates a list of electronic transactions and references—or “links” back—to the parent block, via an effectively mathematically unique digital fingerprint of the previous block or so-called block “hash.” As such, in a blockchain 400, each block 400 contains a hash of its parent block, thus, linking blocks in the chain via a sequence of hashes all the way to the very first block or so-called “genesis” block.

Blocks 410 have certain storage capacities and, when filled, are closed and linked to the previously filled block 410, forming the blockchain 400. All new information that follows the mostly recently added block 410 is compiled into a newly formed block 410 that will then also be added to the chain once filled. As shown, in some embodiments, each block 410 may include a block header 420 and a transactions list 430.

The structure of the blockchain 400 makes it almost impossible to change any of the blockchain's data. Because a current block's hash incorporates and, thus, affects a previous block's hash in the blockchain 400, changing or modifying a parent block would modify a hash of its child's block. In turn, changing or modifying a child block would modify a hash of a grandchild's block and so on. Such a structure may, for example, ensure that, once a given block 410 has a larger or otherwise sufficient number of subsequent or next generation blocks, that block 410 may be difficult to modify due, at least in part, to the considerable effort and expense that would be involved in re-computing all previous blocks. This data structure of the blockchain 400 inherently makes an irreversible timeline of data when implemented in a decentralized nature. When a block 410 is filled, it is set in stone and becomes a part of the timeline. Each block 410 in the blockchain 400 is given an exact timestamp when it is added to the chain.

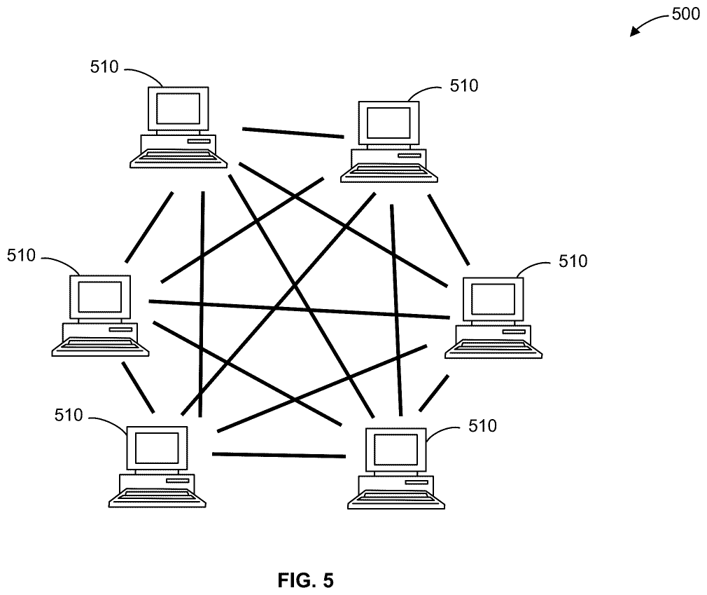

A blockchain structure for the non-fungible tokens 40 of ecosystem 10 relies or can be supported by a peer-to-peer (P2P) network of computers. FIG. 5 illustrates an example of such peer-to-peer (P2P) network 500.

Peer-to-peer network 500 is a decentralized network communications model for computing that comprises or is made up of a group of computing devices 510. Each computing device 510 of the network is considered a “node.” The computer nodes 510 in the peer-to-peer network 500 collectively store and share files, for example, the blocks of the blockchain.

Each computer node 510 in the network 500 acts as an individual peer. Communication between and among the peer computers 510 is performed without any central administration or server, which means that all nodes or computers 510 have equal power and perform the same tasks. The computer nodes 510 are interconnected with each other such that every node is an “administrator” of the blockchain which can access as well as modify data.

The peer-to-peer network 500 can be used to support the blockchain 400 or ledger of transactions for the non-fungible tokens 40, smart contracts, content, accounts, and/or other data and information used in ecosystem 10 of the present disclosure. Referring to FIGS. 4 and 5, in some embodiments, the computers 510 of the network 500 analyze the shared digital ledger of the blockchain 400 at regular intervals. New transactions (e.g., blocks 410) on the blockchain 400 must be confirmed by a predetermined number of computer nodes 510. When a new block 410 of transactions for the non-fungible tokens 40 of the ecosystem 10 gets the stamp of approval from enough computer nodes 510, the new data is written into the current block 410 and the blockchain 400 moves on to considering another list of new transactions which are then committed to the next block 410 in the chain.

In some embodiments, one or more of the computer nodes 510 of the peer-to-peer network 500 may comprise or be implemented on one or more of the servers and computers of the networked computing environment 200 of FIG. 2.

In some embodiments, one or more transactions within a block 410 may be validated by blockchain mining. In blockchain mining, a particular type of network node 510, known as a mining node or “miner,” validates a block of electronic transactions such as for inclusion in the blockchain 400, for example, by solving a mathematical problem or puzzle via one or more cryptographic hashing operations, secure randomized distributed election process, etc., which may qualify the mining node for a reward and/or appropriate fee.

As the blockchain network or architecture is self-auditing (i.e., it automatically checks and updates itself periodically), there is transparency of data between the computer nodes 510. Further, the chances of data corruption are negligible, as the data is not stored at a single location. Additionally, if any unit of information is required to be altered, it requires a huge amount of computing power to override the entire peer-to-peer network 500.

Compared to the Internet, operations, transactions, and processing on a blockchain network are typically slower because they are distributed. In some embodiments, systems and methods of the present disclosure use or implement a NEAR blockchain protocol. In some embodiments, the systems and methods use or implement sharding, which splits the network's infrastructure into multiple segments so that each computer node 510 is only required to handle a fraction of the network's transactions. With sharding, each participating computer node 510 is only required to store a small subset of the blockchain data. By distributing segments of the blockchain 400 across participating nodes 510, sharding provides a more efficient way to retrieve network data and scale the platform. Sharding also enables a greater amount of transactions per second and lower transaction fees.

### Creating a Community or Club

It is expected that many, if not most, users who interact with ecosystem 10 may not possess or have the technical knowledge to set up the one or more clubs or communities 20 with which they are involved as members 30. For example, as previously described, each community 20 in ecosystem 10 can be its own decentralized autonomous organization (DAO) and utilize non-fungible tokens, blockchain, smart contracts, etc. for enabling access, control, and governance. The process of creating a decentralized autonomous organization (DAO) in and of itself can be difficult and complicated, involving multiple and different types of techniques, tools, and services. The same applies for non-fungible tokens, blockchain, smart contracts, etc.

In accordance with some embodiments, systems and methods are provided that allow a user, e.g., in ecosystem 10, to readily or easily create a new community or club 20. In some embodiments, the systems and methods of the present disclosure facilitate the creation and management of NFT-gated communities 20, for example, by providing a single “plus” button (active element) on a graphical user interface (GUI) which a user can “click” or “press” to create a new community.

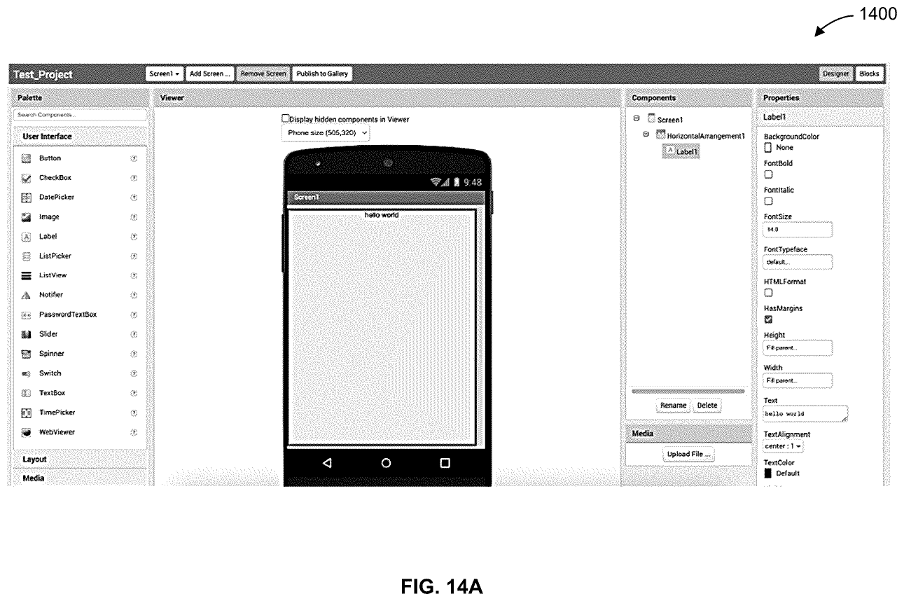

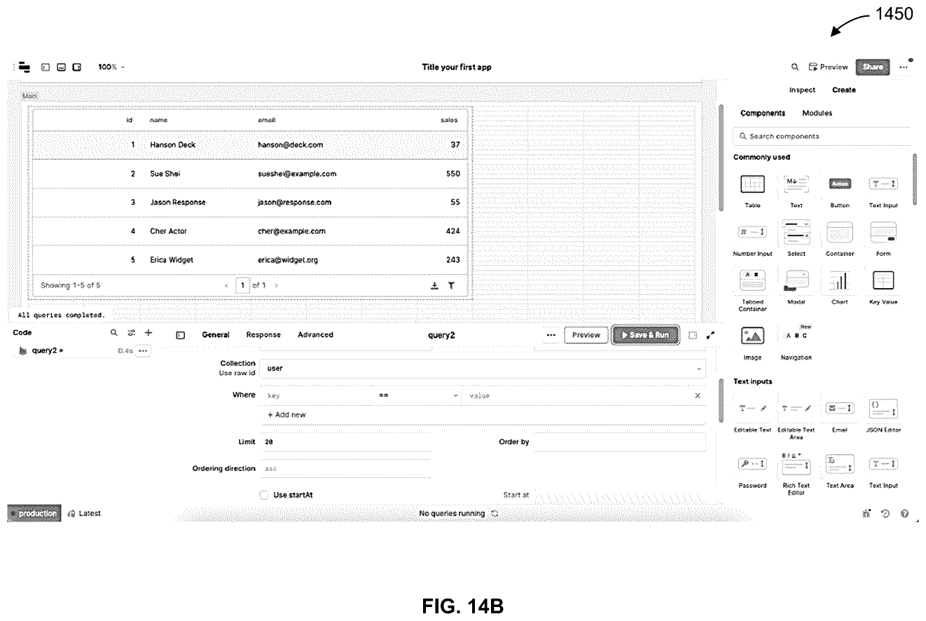

In some embodiments, systems and methods of the present disclosure implement, provide, or support no-code or low-code development of one or more gated communities 20, including the related or associated decentralized autonomous organizations (DAOs), smart contracts, etc. FIGS. 14A and 14B illustrate examples of user interfaces 1400 and 1450 for no-code or low-code development, according to some embodiments. With no-code and low-code development, the systems and methods enable users or members in ecosystem 10 to create software, applications, programs, and code through one or more GUIs and configurations rather than with conventional computer programming where a person is required to write code. Referring to FIG. 14A, in example user interface 1400, the interface presents the user with various options for defining, configuring, or setting up aspects of a gated community 20, such as user interfaces, layouts, media, and options for the same (e.g., button, checkbox, image, label, list picker, etc.). The user can pick and choose from the options and make changes, by “clicking” or “dragging and dropping,” and a viewer box or window previews to the user what the interface being created will look like. The users are actually controlling the generation of the code for the application, but without the requirement for them to write or manipulate the code text.

FIG. 9E shows an example of a screenshot of a user interface 950 with a “plus” button 951. As shown in this example, the plus button may appear near the icons 952, 954, 956, and 958 for the various communities or clubs to which the user is a member. The plus button itself can be an active element or icon.

The plus button 951 simplifies the process of the complicated action of creating a new community by providing a single contextual entry point. After the “plus” button is activated, the systems and methods of the present disclosure will present one or more GUIs to guide a user through some of the tasks or input required, and automatically handle or take care of much of the logistics for creating the community.

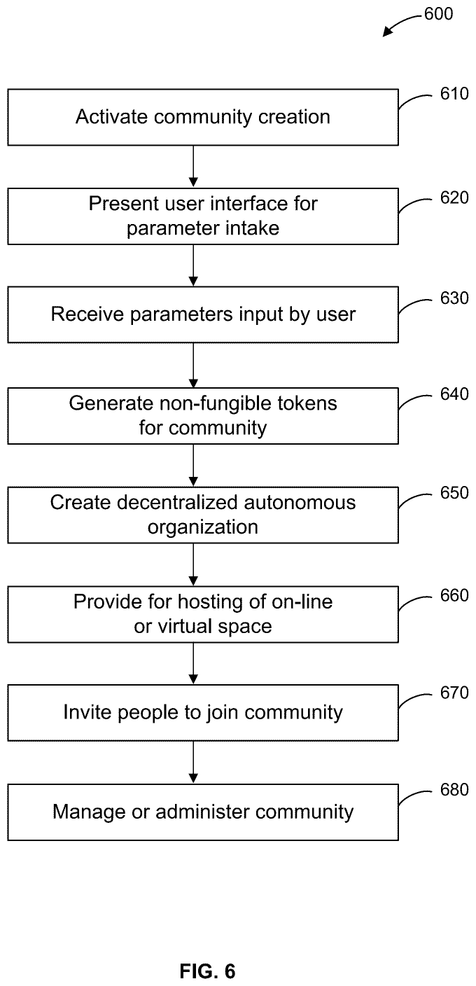

FIG. 6 is a simplified diagram of a method 600 for creating and managing a new community 20 responsive to user action, such as pressing of a “plus” button on the user interface. In some embodiments, the user interface with “plus” button is supported or available through application 50 running on user device 60. One or more of the processes 610-680 of method 600 may be implemented, at least in part, in the form of executable code stored on non-transitory, tangible, machine-readable media that when run by one or more processors—such as may be present, for example, in user device 60 shown in FIG. 1 or one or more servers 210, user computers 220, and mobile devices 230 of the networked computing environment 200 shown in FIG. 2—may cause the one or more processors to perform one or more of the processes 610-680. The processes 610-680 are exemplary, and need not be performed in the particular order show in FIG. 6. In other embodiments, one or more of processes 610-680 may be omitted, the order changed, and other processes added.

At a process 610, the “plus” community button is activated by the user's action, e.g., of pressing or clicking at the user interface of application 50. In some embodiments, application 50 may provide or support an interface for the entire ecosystem 10, including all of its communities 20. As such, any community 20 can be accessed through a single application 50 on user device 60, and users are not required to download, install, or open a separate application for each community to which they belong. For example, as shown in FIGS. 9E and 9F, many or all of the communities to which a user belongs are represented by corresponding icons 952, 954, 956, and 958 on a single user interface presented by the application 50. The application interface can provide or support a feed of content, messages, texts, etc. for each community 20, and a user who is a member of multiple communities may readily jump or move from one feed to another, for example, by pressing or clicking on the corresponding icon 952, 954, 956, 958. As a user is viewing or participating in the feed for one community, she/he/they may be inspired to create a new community. Pressing the “plus” button 951 activates or starts the creation of a new community.

In response to the activation, at a process 620, the application 50 on user device 60 brings up or presents one or more screens or a flow where the user may enter or select parameters for managing the new (decentralized) club or community 20. These parameters may include, for example, a name for the community (e.g., “Santa Monica Plant Club”) and a brief description of the community (e.g., “A space for plant lovers in Santa Monica, California, to connect, discuss, learn, share and sell all things plants.”). The parameters may also include content (e.g., photographs, video files, audio files, etc.) for on-line or virtual space of the community. The creating user may be asked or directed to select or designate a particular image or photograph to be the “cover” image for the new community. The parameters may further include or relate to some basic rules of governance or control over the community, such as whether decisions are made by consensus, majority vote, whether any particular member or groups of members have a veto right, and whether the community is private (where the community's content and postings are viewable by only the community's members) or public (where anyone can view the community's postings or content). The parameters may also relate to or concern the intake, collection, distribution, spending, disbursement, etc. of funds or monies for the community. In some embodiments, the parameters may also include the names or contact information (e.g., phone number or email address) of potential members for the community. In some embodiments, the user can enter contact information for several people, each separated by a common or semicolon. In some embodiments, the application 50 is able to access the contact information that may be stored on the user device 60 so that the user is able to select directly from the same. At a process 630, the application 50 receives the creating user's input for each parameter.

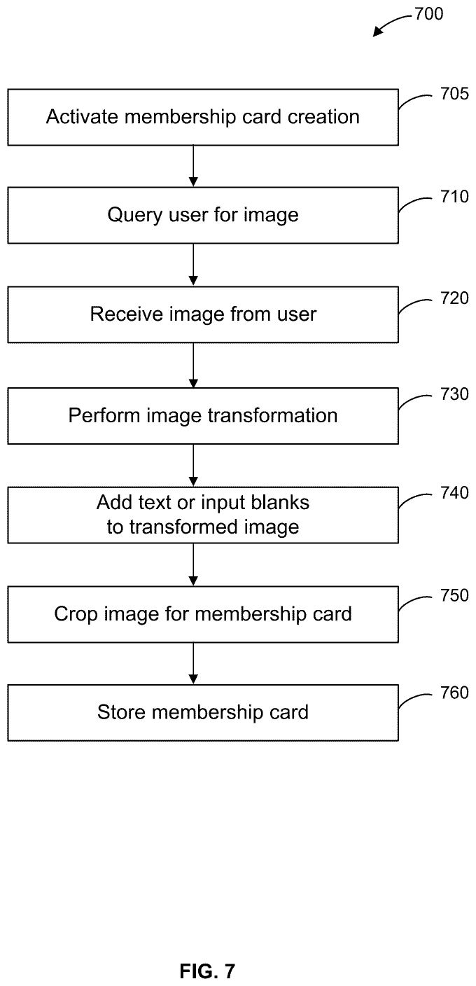

At a process 640, the received parameters are used to generate or mint non-fungible tokens 40 that may be used for membership in the new community 20. In some embodiments, membership tokens 40 can be generated using one of the images provided by the user. The image is processed or transformed into a “membership card.” In some embodiments, when the club creator uploads an image to use as the basis for the membership card NFT, the image is sent through an image processing pipeline. The image is scaled to the appropriate starting size. The features of the image are softened and blurred. A metallic sheen is added. Club metadata is added to the appearance of the card, such as the club name and NFT edition number. Each member receives a unique card which can be distinguished by the edition number. This is described in more detail below with reference to FIG. 7. In some embodiments, the systems and methods include or implement programming interfaces which use datasets of inappropriate and copyrighted names to prevent the creation of accounts with certain usernames (e.g., usernames with profanity, third party trademarks, etc.).

One or more of communities 20 in ecosystem 10 are run, organized, or structured as a decentralized autonomous organization (DAO), which has no central governing body and whose members 30 share a common goal to act in the best interest of the organization or community. It is contemplated that while many members and creators may prefer to have a DAO structure for their communities 20, they may not understand what a DAO is, much less how to implement, set up, or structure one.

Thus, according to some embodiments, at a process 650, the systems and methods of the present disclosure (e.g., modules, applications, routines running on computer hardware such as the servers and computers discussed with respect to FIG. 2) automatically create or provision a decentralized autonomous organization (DAO) for the new community 20 based on, among other things, the non-fungible tokens 40 and/or user input. In some embodiments, one or more parameters input by the creating user are converted into smart contracts for the DAO. For example, based on input or parameters provided by the user, systems and methods of the present disclosure identify appropriate or relevant forms of smart contracts; fill-in, modify, or complete the form smart contracts, e.g., for implementing or executing transactions (such as selling song releases, concert or event tickets), voting on action items, elections of new officers, admission of new members, deletion or removal of existing members, the deletion or removal of text, comments, discussion, images, audio or video content; and store, maintain, deploy, or execute the completed smart contracts in order to implement or support the DAO. In some embodiments, the form and completed smart contracts are maintained in one or more libraries or databases in the servers and computers of computing environment 200 (FIG. 2).

The smart contracts can implement the policies, processes, procedures, rules, bylaws, etc. for the DAO or community 20 as the members interact. For example, one or more smart contracts may provide or support the processes or procedures for electing officers for a community, including opening up the election, issuing ballots to voting members, receiving and counting votes, and announcing the winners. As another example, a smart contract may provide or support the processes or rules for admitting new members to a community (e.g., upon a majority vote of existing members). One or more smart contracts may relate to the policies or bylaws for how to disband or dissolve the community, and what happens to the community's assets and content in such situation. As yet another example, a smart contract may provide or support the sale or purchase of various goods or services between members of a community—e.g., one member selling a digital item (such as digital artwork) to another member. The smart contracts are self-executing. For example, once the purchaser of the digital item has authorized payment to the seller, the smart contract causes the funds to be disbursed to the seller, and transfers rights to the digital artwork from the seller to the purchaser.

In some embodiments, the systems and methods of the present disclosure provide, support, or implement no-code or low-code development for creating, generating, and/or deploying configurable smart contracts instantly. The users, interacting with the systems and methods through one or more GUIs, control the generation of the code for the smart contracts, but are not required to write or manipulate the code text. In response to information or parameters entered or selected by the users, the systems and methods provide or support batch processing for the smart contracts (e.g., in real time), and transpose the same to blockchain.

In some embodiments, a user wanting to start or create a new community 20, and who is already a member of one or more existing communities 20, may be presented with the option to adopt, copy, emulate, follow, or use one or more aspects or structures of an existing community 20 when creating the new community. For example, the processes 630 and/or 650 may query the user creating a new community whether she/he/they would prefer to follow or emulate some part of an existing community. If the user answers or responds in the affirmative, the systems and methods may present the user with a list of all communities 20 to the which the user already belongs, and give the creating user the option to select one of these communities to emulate or follow. In some embodiments, the systems and methods may pose or make multiple queries to the creating user, e.g., for different aspects or structures for the new community. For example, a user might prefer the governance structure of a first existing community 20, the membership admission and removal process of second existing community 20, and the policy for removing or deleting discussions and comments of a third existing community. The systems and methods of the present disclosure will present the creating user with a list of all communities for each topic or subject (e.g., governance, membership policy, deletion policy), and the user is allowed to select from the same.

Where the creating user is presented with and allowed to select from existing communities for emulating or copying similar structures, aspects, policies, etc. for creating the DAO for the new community, the systems and methods will reference or pull from the smart contracts of relevant existing communities selected by the user. The systems and methods can copy and modify those smart contracts from the existing communities to generate appropriate smart contracts for the new community. Or alternatively, the systems and methods can automatically identify which forms correspond to those smart contracts (e.g., in the smart contract forms library), and populate, fill-in, or modify the forms as appropriate to implement the choices or preferences of the creating user, thereby setting up the DAO for the new community 20.

In some embodiments, the systems and methods will present the creating user with one or more user interface (e.g., screens) to receive or confirm the user's preferences. For example, the systems and methods may analyze or determine (based on the relevant smart contract) that the governance structure for selected existing community is by majority vote, and present the creating user with a screen that specifies that voting of for the new community will be by “majority” of its members, which is the same as or consistent with the user's selection. At the user interface, the creating user is given the option to confirm, or to select some other type of voting, e.g., “unanimous.”

In another example, the user is provided with a GUI for inputting, selecting, defining, or specifying different levels or privileges of membership. For example, it may be desirable that only some members (but not all) will be granted to the right or privilege to post content, call for a vote or election, allocate or spend funds, etc. In a further example, the creating user is presented with one or more interfaces to select or input how funds are collected, allocated, and distributed.

The systems and methods intake the user parameters or selections, and automatically generate, complete, or create the one or more smart contracts for implementing the desired governance, rights and privileges, funding, etc. for the DAO or community. In some embodiments, this code, e.g., for the smart contracts, created or generated by the systems and methods of the present disclosure, along with other information and data for the community, are maintained or kept on the blockchain (see, e.g., FIG. 4). In this way, the systems and methods of the present disclosure implementing and supporting the ecosystem 10 may transpose what happens in a conventional social network to the blockchain. Ecosystem 10 and its communities are decentralized. The ecosystem may serve as the custodian of the propriety information, content, etc. of the communities and their members. In some communities, human administrators are not in charge, and administration of the community by fiat is not enabled; the community is governed by its smart contracts.

At a process 660, the systems and methods of the present disclosure provide for hosting of an on-line or virtual space for the new community 20. In some embodiments, this may involve allocating or assigning one or more computer resources (e.g., network servers, processors, memory, etc.) to support the virtual space. The photograph or image selected by the creating user can used as the cover image for the new community.

Information for the new community or club is shown or presented, for example, in the user interface for application 50, similar to some conventional community or social media applications. Examples of screenshots for user interaction with the on-line space for such communities are shown in FIGS. 9A-9F, as described herein. However, unlike conventional applications, membership to the new club is automatically managed through ownership of the non-fungible tokens 40. Not anyone can join the new club.

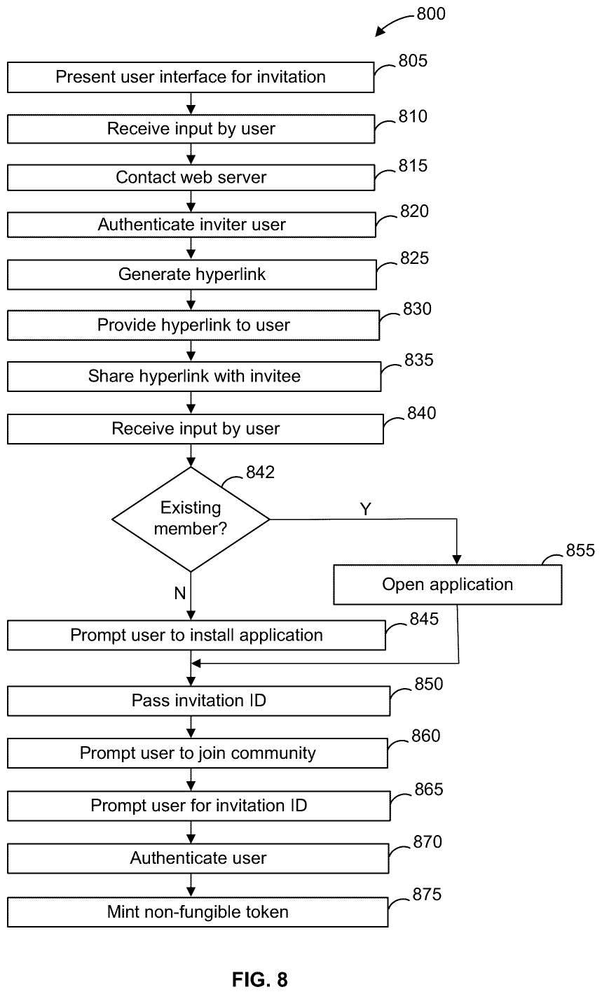

At a process 670, certain people or users are invited to join the new community 20. In some embodiments, the systems and methods of the present disclosure may generate a unique hyperlink containing a randomly generated “invitation ID,” which the creating user may share with people she/he/they wishes to invite to join the community. In some embodiments, one or more non-fungible tokens 40 are created or minted in connection with this process 660. This is described in more detail below with reference to FIG. 8.

When users accept their invitations, they become members 30 of the new community 20, and the community will begin to take shape. The members 30 may interact, bond, and share with each other, for example, using the application 50 on their respective user devices 60.

At a process 680, the systems and methods of the present disclosure manage or administer the community—e.g., for rights management, shared governance, admission and expulsion of members, income and financial transactions, etc. Users or members may participate or interact in the virtual or on-line space for the community through the application 50 running on respective user devices 60. As the users are interacting in their community, they may take actions, such as uploading or posting comments, engaging in discussions, voting for officers, selling and buying products and services, etc.

These actions and interactions may be governed or controlled by, or subject to, policies, rules, settings, procedures, or processes that have been set up, defined, or established for the community. For example, during the parameter intake process, a creating user may provide input or designate that the new club is to be private, in which case, only members or users holding the requisite non-fungible tokens 40 for the club can view or see any posts in the community. Alternately, a creating user may designate that the certain aspects or content for new club is to be public such that, for example, anyone, including non-members, can view posts in the community. The policies, rules, procedures, processes, etc. for the community are deployed or implemented in the smart contracts of the DAO. In some embodiments, the settings and policies of the community 20 are managed and enforced through the application 50 and centralized web servers (see e.g., FIG. 2). In some embodiments, the settings and policies of the community 20 may be handled directly through the blockchain protocol supported by the computer nodes 510 of the peer-to-peer network 500 (see e.g., FIGS. 4 and 5).

In some embodiments, user or member actions or interactions in the on-line or virtual spaces for the communities 20 correspond to predefined events in the application 50 and/or programs running on user device 60 or computers, servers, nodes of the computing environment. In some cases, such events relate to or are associated with the smart contracts that have been created and deployed for the communities 20. An event may trigger, initiate, or cause one or more smart contracts to execute in order to carry out the policies, rules, processes, etc. set up for the community. Thus, for example, one member action can be the upload or deletion of content that the member has contributed to the community. The application 50 recognizes or determines that this user action is a triggering event relating to content rights management, and causes or invokes smart contracts relating to the same to execute. As another example, a member action can be the opening of an election of officers for the community. The application 50 recognizes or determines that this user action is a triggering event for an officer election, and invokes or causes the one or more relevant smart contracts to run for the election. In some embodiments, systems and methods of the present disclosure record one or more such events for the application and programs in the blockchain 400.

In some embodiments, when a club is created in the application 50, an asynchronous job is queued and run to deploy a NEAR smart contract. The smart contract derives from a template contract used to represent clubs or communities 20 on the NEAR blockchain. Each club or community 20 is given a unique “slug” to identify it on the block. This is a globally unique lowercase space-free string. For example, the identifier for “Santa Monica Plant Club” would be reduced to “santamonicaplantclub” (if that name is available). Arbitrary numbers are appended at the end of each slug to make it globally unique if necessary. The contract is deployed using a NEAR address with the pattern slug.clubs.nicheprotocol.near. Using a system of hierarchical, separated names resembles web domain names. From the example above, the “santamonicaplantclub.clubs.nicheprotocol.near” could plainly and clearly be identified as belonging to the Niche ecosystem 10; thus allowing for higher levels of trust and security.

Method 600 simplifies or facilitates the creation of a new community 20 in ecosystem 10, by handling or taking care of any of the logistics and processes for the creation and administration of tokens, blockchains, self-executing agreements, decentralized autonomous organizations, governance, etc. so that the creating user does not need to do this. As such, one or more of the processes of method 600 may be invisible to the creating user.

Thus, the systems and methods of the present disclosure, in some embodiments, may allow people to create new decentralized communities directly from the feed where they are consuming content and interacting with the existing ones they are members of. As such, a user of the systems and methods of the present disclosure is not required to, for example, engage with or create with a DAO on a service like Discord, go to a different platform or service to create a non-fungible tokens for community, and yet another one to distribute and govern the community as a DAO.

In some embodiments in which the NFT-gated community is created through the click of a button, the technological efficiency of this process is substantially faster (up to 98.8% faster) than conventional processes. Conventional processes at baseline involve multiple resource steps including creating digital assets, minting NFTs and generating smart contracts, which collectively on average take about 90 minutes. The simple “one button” press tool and process supported by the systems and methods of the present disclosure can generate all aforementioned processes in less than a minute.

Generating NFT Membership Cards from Community Photographs or Images

With a token economy, the user or members 30 own the community 20 and its content. The clubs or communities 20 in ecosystem 10 are exclusive, as membership is by invitation only and access is granted through the non-fungible tokens 40. According to embodiments of the present disclosure, systems and methods are provided for creating digital art representative of a membership into an exclusive community. In some embodiments, the source material for the digital art can be a photograph or image uploaded or selected by the creating user to be the cover image of new community 20. In some embodiments, the digital art is used to generate a membership card which is provided to each member 30. Such membership card helps to reinforce the exclusivity of the clubs and communities 20 in ecosystem 10.

FIG. 7 is a simplified diagram of a method 700 for generating membership cards for a community, according to some embodiments. One or more of the processes 705-760 of method 700 may be implemented, at least in part, in the form of executable code stored on non-transitory, tangible, machine-readable media that when run by one or more processors-such as may be present, for example, in user device 60 shown in FIG. 1 or one or more servers 210, user computers 220, and mobile devices 230 of the networked computing environment 200 shown in FIG. 2—may cause the one or more processors to perform one or more of the processes 705-760. The processes 705-760 are exemplary, and need not be performed in the particular order show in FIG. 7. In other embodiments, one or more of processes 705-760 may be omitted, the order changed, and other processes added. A user may be involved or have a role in one or more of processes 705-760.

At a process 705, the method or process for membership card creation is activated, for example, by the user pressing on an active element (e.g., icon or button) presented in a suitable user interface presented by application 50 running on a user device 60. In some embodiments, this user can be the user creating a new community 20 as discussed with respect to FIG. 6. In some embodiments, this user can be a person who has received an electronic invitation to join a community, where the electronic invitation includes a hyperlink or other active element. When the invited user clicks or otherwise activates the hyperlink or active element, the systems and methods of present disclosure (e.g., modules, applications, routines running on computer hardware such as the servers and computers discussed with respect to FIG. 2) present to the user an interface on the user device 60 for token or membership card creation.

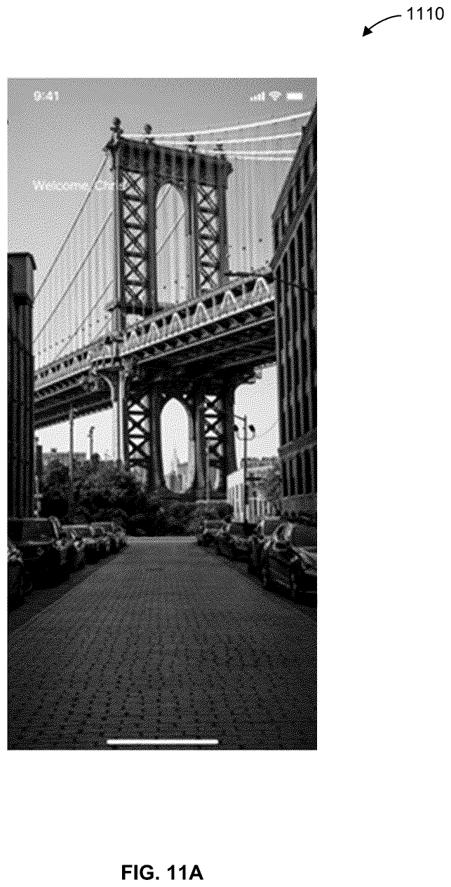

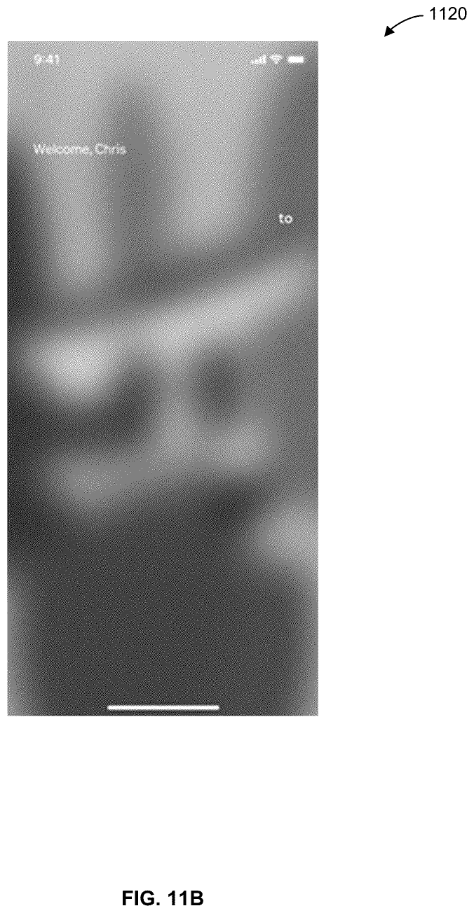

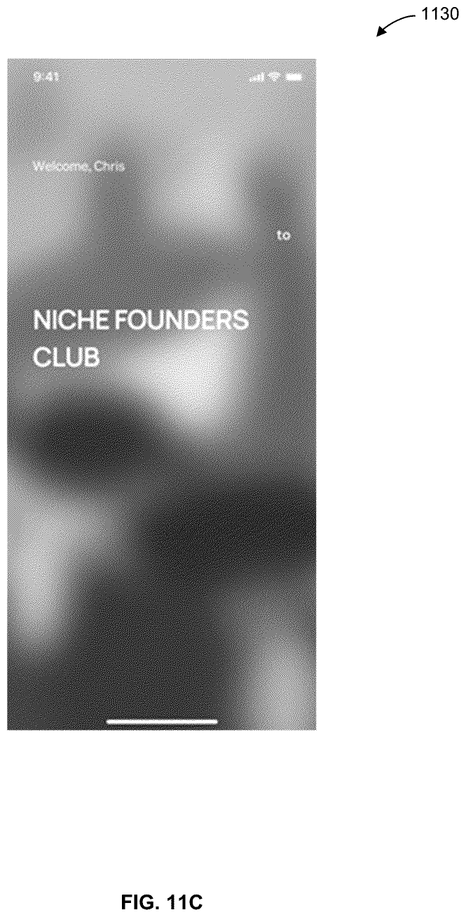

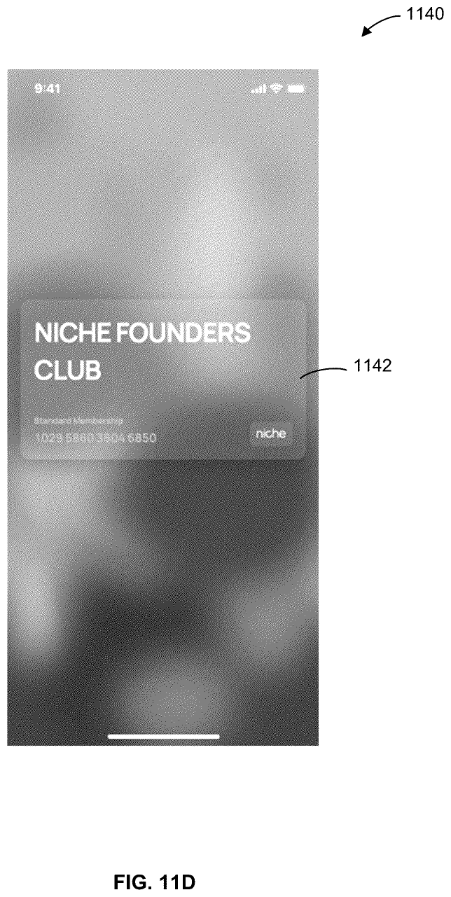

At a process 710, the user is queried or prompted to select or input an image (e.g., photograph). In some embodiments, the query or prompt can be presented at the user interface supported or provided by application 50 running on user device 60. The image can come from a user's photographs (e.g., stored on user device 60), uploaded from another location (e.g., a user computer 220), or come from the web. An example of a screenshot 1110 with such an image or photograph, e.g., of the Manhattan Bridge, is shown in FIG. 11A. The image may have some significance to the new community, for example, being a photograph of the city where the founding member or potential members reside, or a photograph of the artist or band that is the focus of the community, or a logo for the sports team or club of interest. This image will be used as the base or source material in creating a membership card for one or more members 30 of a particular community 20 (existing or new). The membership card can serve as a visual identifier of that community 20 and/or one or more of its respective members 30.

At a process 720, the image input or provided by the user is received and uploaded, for example, at a web server 210 of the networked computing environment 200. The web server 210 executes a custom pipeline to process the chosen image.

At a process 730, the web server 210 performs a series of image transformations or processing to transform the selected image or photograph into an abstract design. For example, the image can be filtered or blurred so that its details not readily apparent. This is shown, for example, in the example screenshot 1120 of FIG. 11B. In some embodiments, the computer server may comprise, incorporate, or implement a Convolutional Neural Network (CNN), General Adversarial Network (GAN) or like neural network for generative machine learning or artificial intelligence. The CNN, GAN, or other neural network may be trained with one or more images of abstract paintings or art, and configured to generate similar images based on additional input images. The computer server can implement or perform various techniques or algorithms, such as gamut compression, gradient filtering, neutral style transfer (NST), diffusion, etc. In some embodiments, the neural network may include or be implemented with a generator network and a discriminator network.

In some embodiments, the systems and methods of the present disclosure provide the creating user with the ability to select or choose the level or extent of transformation, e.g., with one or more interfaces and screens. For example, in some embodiments, the image transformation is presented or displayed to the creating user in real time on a user device 60. The user can “click” on the image at any point, thereby halting further transformation and selecting the desired level of abstraction.

At a process 740, the web server 210 appends or adds text or input blanks to the transformed image or abstract design. This text can include, for example, the name of the community 20, a level of membership (e.g., standard or premium), and a membership number, as seen in the example screenshots of user interfaces 1130 and 1140 of FIGS. 11C and 11D. In some embodiments, at least some of the items added at this point simplify specify information to be added later, e.g., a particular member's name, membership number, and/or starting date of membership, which can be filled in later. In other words, the method 700 creates or generates a format for the membership card of the community 20.

In some embodiments, the membership cards are preferably dimensioned in a standard credit-card like format, recognizable by many users as such and consistent with the users' experiences of membership cards in the real world. However, the dimensions of most images or photographs are not sized consistent with the standard credit-card format.

As such, at a process 750, the transformed image or abstracted design is cropped to a standard credit-card format, for example, as seen in FIG. 11D. In some embodiments, the web server 210 selects the portion of the image to crop. In other embodiments, the creating user may select the desired portion of the image. For the latter case, in some examples, the user device 60 presents the creating user with a template or outline shaped or dimensioned in standard credit-card format. The outline may appear as an overlay on the abstract design. The creating user may move the template over the abstract design to see how a membership card would look like using different portions of the abstract design. When the user finds a portion of the design that is appealing for the membership card, the user can select that portion for cropping. This is illustrated in FIG. 11D, showing a membership card 1142 defined in and cropped from an underlying abstracted image.

In some embodiments, the systems and methods of the present disclosure provide or support tools, user interfaces, etc. that allow a club member or user with administrative rights to create a form membership card that can be used as a default form for generating the respective membership cards or non-fungible tokens of each member of the community. In other words, the membership cards of at least some, up to all, members of the community will look similar, e.g., with respect to background image, placement of text, etc.

In some embodiments, the systems and methods of the present disclosure provide or support tools, user interfaces, etc. that allow one or more members (or people invited to be members) to create their own customized membership cards. Thus, for example, a member of the Santa Monica Plant Club may select an image of her/his/their favorite plant (e.g., fern, rose bush, cactus) as the starting image for a respective membership card. Likewise, for example, a member of the Porsche Drivers Club may select an image of her/his/their favorite model of Porsche automobile (e.g., 911, 914, 928, Boxster, Cayenne, Macan) as the starting image for a respective membership card.

At a process 760, the generated images and/or membership cards are stored on a server, such as one of the servers 210 of the networked computer environment 200 shown and described with reference to FIG. 2. In some embodiments, a separate membership card is generated for each person who is invited to join a club or community 20, for example, by inserting details into the form membership card.

In some embodiments, each membership card implements, is associated with, or serves as a non-fungible token that, among other things, allows its associated user to access the respective on-line community 20 as a member 30.

In some embodiments, the generated membership cards can be included in invitations sent out to users who might be interested in joining the new community 20 as members 30. In some embodiments, a membership card is only generated after a person who has been invited to join a community has accepted the invitation, for example, by clicking on a hyperlink embedded or included in an electronic invitation.

In some embodiments, systems and methods of the present disclosure may allow a user who has accepted an invitation to join a community to replace the default or form membership card with a customized version, for example, by providing or supporting one or more interfaces for card creation.

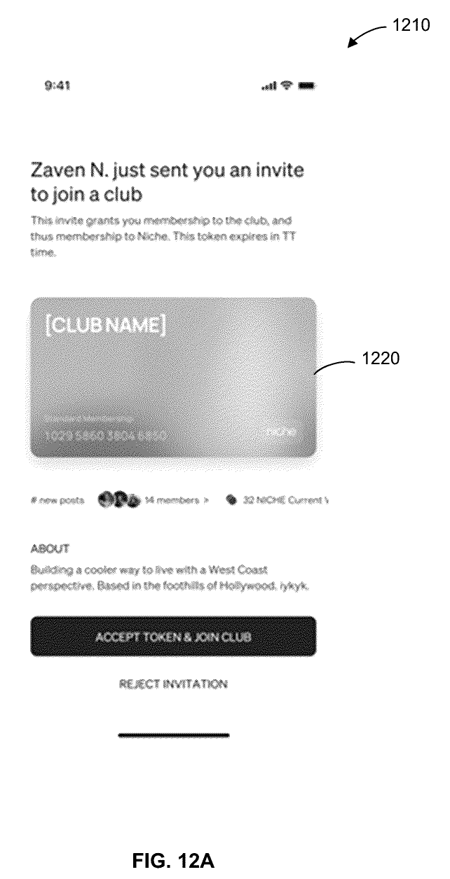

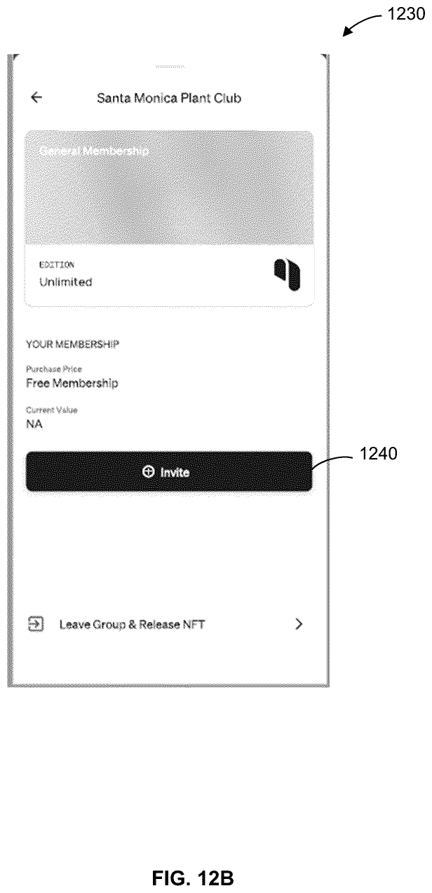

FIG. 12A shows an example of user interface 1210 with a membership card 1220. In some examples, the membership card 1220 looks like a standard physical credit card or membership card that a user might have in the real world, and may include information for community name, the level of membership, the (potential) member's name and/or member number. The membership card 1220 provides or gives the user a sense of privilege for belonging to an exclusive community 20.

In some embodiments, the systems and methods of the present disclosure generate or create membership cards for both active members 30 of a community 20 as well as for people or users who have been invited to join a community. FIG. 12A shows a user interface 1210 with a membership card 1220 being presented to a user who has been invited to join a community.

In some embodiments, systems and methods of the present disclosure may use the membership cards as mechanisms for or in conjunction with providing a non-fungible token 40 to an invitee user or potential member, as shown, for example, in FIG. 12A. In some embodiments, the membership cards are referenced through a hyperlink without the smart contract that is deployed governing the non-fungible tokens 40 for the decentralized autonomous organization (DAO) of the community 20.

A membership card may also be displayed to a user who is already a member 20 of a community, for example, a membership page 1230 as shown in FIG. 12B. Active members 20 of a community may be provided with the ability to invite other people to the community, for example, through an active icon 1240.

With method 700, the systems and methods of the present disclosure can create many unique non-fungible tokens 40 to gate all of the different decentralized communities 20 of ecosystem 10. The tokens and/or membership cards can be used by respective members 30 to gain access to both the virtual, on-line space of the community as well as activities or meetings that occur in the real world, e.g., concerts, races, etc.

Generating and/or Receiving a Non-Fungible Token Through an Invitation Link

In ecosystem 10, access to communities 20 is gated using non-fungible tokens 40 which are assigned to or owned by the members 30 of the communities. According to some embodiments, the systems and methods of the present disclosure provide a seamless way to create or mint non-fungible tokens 40 using a single or multi-use URL or link that can be sent to a person or invitee through any communication channel, such as text message, email, social media, etc. When that person clicks on that link, the token or tokens are seamlessly created (minted) and deposited into that person's wallet (or a custodial wallet is created for her/him/them if she/he/they do not already have one on the application 50). The digital wallet allows a user to quickly view of all of her/his/their digital memberships. In some embodiments, the user can only see content and participate in conversations for a particular community 20 if she/he/they holds or possesses the necessary membership card or non-fungible token 40 issued by the application 50 and the systems and methods of the present disclosure.

FIG. 8 is a simplified diagram of a method 800 for receiving a non-fungible token through an invitation link, according to some embodiments. One or more of the processes 805-875 of method 800 may be implemented, at least in part, in the form of executable code stored on non-transitory, tangible, machine-readable media that when run by one or more processors—such as may be present, for example, in user device 60 shown in FIG. 1 or one or more servers 210, user computers 220, and mobile devices 230 of the networked computing environment 200 shown in FIG. 2—may cause the one or more processors to perform one or more of the processes 805-875. The processes 805-875 are exemplary, and need not be performed in the particular order show in FIG. 8. In other embodiments, one or more of processes 805-875 may be omitted, the order changed, and other processes added. A user may be involved or have a role in one or more of processes 805-875.

At a process 805, a user, who may already be a member 30 of a community 20, is presented with the ability to invite others to join the community. An example of a screenshot for a user interface 1230 for inviting another person to join a community is shown in FIG. 12B. Such user interface can be supported or provided by application 50 running on user device 60 or other user computer. In some embodiments, a query, prompt, or active element (e.g., button) 1240 is presented at the user interface 1230 for inviting a person to join the community 20. If the member user chooses to invite another person into community 20, the user may activate or respond to the prompt, in which case, the user device 60 receives the user input at a process 810.

At a process 815, the application 50 on user device 60 contacts a web-server (e.g., a server 210 in networked computing environment 200) which stores or maintains information and data for one or more communities 20 in ecosystem 10. The application 50 transmits or provides the account information (e.g., membership information) of the user creating the invitation along with information identifying the relevant community.

At a process 820, the web server authenticates the inviter user, using the account or membership information, to prevent abuse.

At a process 825, the web server generates a unique hyperlink that contains a randomly generated “invitation ID.” In some embodiments, the invitation ID can be a string or secret code that serves as a passphrase in order to mint and receive non-fungible tokens 40 for the given communities 20 (each of which can be a decentralized autonomous organization). At a process 830, the web server transmits or returns the hyperlink to the inviter user.

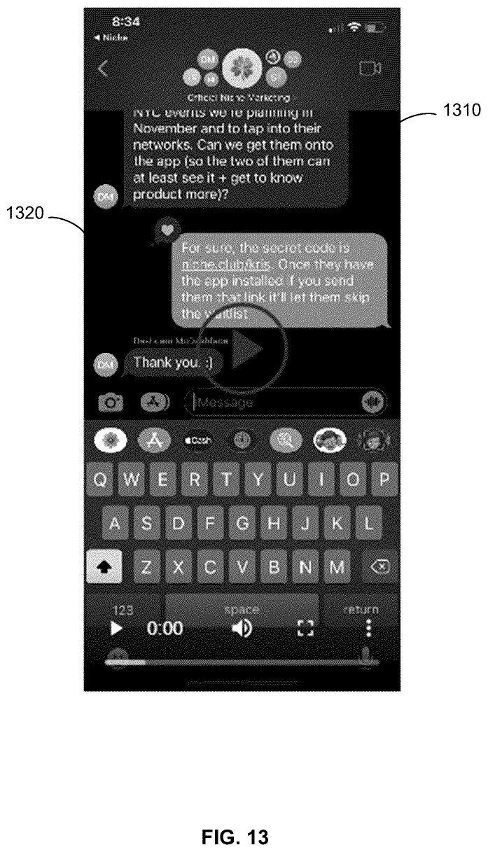

At a process 835, the inviter user then shares this link with the people she/he/they wish to invite to community 20, for example, through one or more electronic invitations. In some embodiments, for example, using device 60 or other user computer, the inviter user transmits the link through an SMS text message, mobile chat application, email, or the like, over a network, e.g., comprising one or more of a local area network (LAN) or a wide area network (WAN), wireless data network e.g., WiFi, Wimax, 802.XX, cellular network, or any other suitable private or public network. An example of a screenshot for such user interface 1310 with invitation ID or secret code 1320 that can be sent from the inviter user is shown in FIG. 13.

The invitee user may have her/his/their own computing device through which she/he/they receives the invitation with hyperlink, e.g., through text message, email, etc. At a process 840, the computing device receives the invitee user's input or “click” on the hyperlink.

If the invitee user is not currently a member of some community 20 in ecosystem 10 or does not already have application 50 installed on her/his/their computing device, when the invitee user clicks on or otherwise activates the hyperlink, then at process 845 the computing device will be prompt the user to install the application 50, for example, by downloading from a suitable app store, while the maintaining the invitation ID within the metadata of the request maintaining. Once the application 50 is installed on the invitee user's device, at process 850 the invitation ID is passed through and read from the metadata.

Alternately, if the invitee user already has the application 50 installed on her/his/their computing device, then clicking on the invitation hyperlink causes the computing device at process 855 to open the application, deep-links into the application, and passes along the invitation ID directly at process 850.

Once inside or interacting through the application 50, at a process 860 the invitee user is prompted to join the decentralized autonomous organization (DAO) or community 20 that she/he/they was invited to. In some embodiments, the systems and method of the present disclosure can present the invitation to the user in a digital wallet (e.g., associated with application 50) for that user. If the user does not already have a digital wallet, the systems and method of the present disclosure can create a custodial wallet for the user.

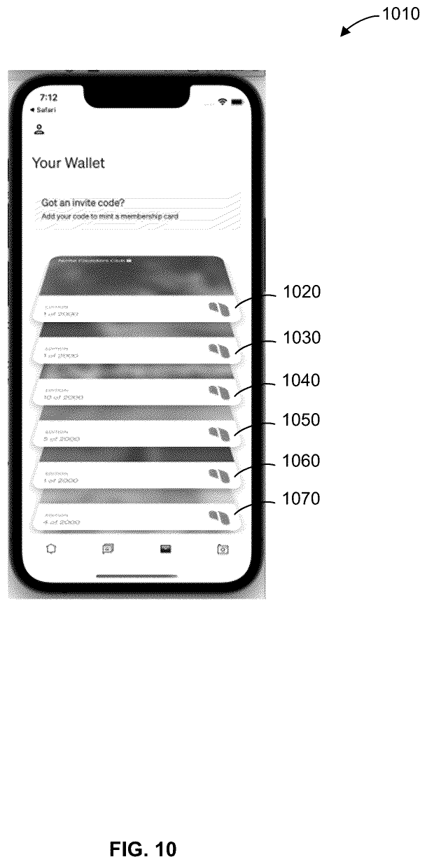

FIG. 10 shows an example of a screenshot of a user interface 1010 for a digital wallet with one or more membership cards 1020, 1030, 1040, 1050, 1060, 1070. The digital wallet may include active membership cards for each community 20 to which a user is already a member 30 and open membership cards for each community 20 to which a user has been invited. In some examples, each membership card 1020, 1030, 1040, 1050, 1060, 1070 (whether active or open) can be associated with an active element or icon that can be “pushed” or activated by the user. Upon activation of the respective active element by the user, the systems and methods (e.g., application 50) will present an interface showing the membership card virtually being removed from the digital wallet and presented in full or complete form on the screen (e.g., of user device 60).

If the invitee user elects or chooses to join a community 20 to which she/he/they has been invited, then at a process 865 the systems and methods of the present disclosure may query the user for an invitation code or ID passphrase. After the user enters the code on her/his/their user device 60, the user device sends a request back up to a web server with the user account information and the invite ID passphrase.

At a process 870, the web server uses this information to authenticate the invitee, for example, by verifying that the user is in possession of the key that grants her/him/them access to the invited DAO or community 20.

At a process 875, the server then generates or mints a new non-fungible token 40, for example, by using a secret key to execute a command to the blockchain. The token 40 is owned or possessed by the authenticated invitee and grants her/him/them access into the decentralized community 20. The system may also create an active membership card for the user for the respective community 20. In some embodiments, the minted token comprises or is embedded, incorporated, or associated with the membership card.

In some embodiments, one or more non-fungible tokens 40 are minted prior to the generation and/or transmission of invitations to join the community 20. The minted tokens 20 are maintained in a blockchain (such as blockchain 400 of FIG. 4) and, in some examples, associated with or related to the invitations prior to the invitations being sent out or transmitted by the systems and methods of the present disclosure.

In some embodiments, each minted token has a shelf-life, e.g., a predetermined period of time after minting or presentation to a user during which time the token must be accepted by the user or it will otherwise expire, and thereafter deleted.

The electronic membership card and/or minted token are added to the invitee user's digital wallet as seen, for example, in FIG. 10. In some embodiments, the systems and methods of the present disclosure can establish or provide for membership to a club or community 20 by invoking the smart contract code via the NEAR RPC protocol. Each user has exactly one “wallet address” and that wallet address can be sent (e.g., by the application 50 running on device 60) via the RPC protocol to any club smart contract (e.g., maintained or running on computers or servers in computing environment 200 or in peer-to-peer network 500). The function invoke is nft_tokens_for_user. If this RPC endpoint returns data, then membership is verified. Alternatively, if the systems and methods determine that this RPC endpoint returns no data, then the wallet address has no entitlement to any NFTs known by that contract, and membership is denied.

In some embodiments, the user can user the membership card or token as a ticket or pass for entry to live events held by the community 20, for example, by “pulling out” the card or token from her/his/their digital wallet so that it presented in full form on the screen of user device 60 where it can be scanned or checked. A user member may use also her/his/their membership card and/or token, for example, to conducts transactions within or gain access to the on-line or virtual space for the community 20.

### Join the Discussion Button/Conversations Instead of Liking

Previously developed social networking applications typically have a “liking” or “hearting” mechanism to leave lightweight feedback, in addition to a comment or replies section. The systems and methods of the present disclosure are different. For each piece of content shared within a community 20, they provide an associated chat room, where the discussion regarding that piece of content can take place in real time. An example is shown in the screenshots 970 and 980 of FIGS. 9G and 9H.

Referring to FIG. 9G, an example for a chat room for the community “The Joy of Clay” is depicted. This chat room provides or supports a discussion, e.g., concerning a particular technique (Sgraffito) that may be of interest to some members of the community. The user interface for the chat room may include or present active elements, e.g., icons or buttons, for following and joining any discussion concerning this topic or content. In some embodiments, any member or only some members may open the discussion in the chat room based on the community's rules or processes. A “Save” button or icon, when “pressed” or activated by the user, will provide the user with updates or notices whenever a new comment is made or entered for the discussion on this topic. A “Comment” button or icon, when “pressed” or activated by the user, will present the user with text box where the user may join the discussion by entering her/his/their own comments or thoughts, either as to the original content or the comments of other users.

After the user has entered a comment (e.g., “Thanks for showing the process’. It looks very interesting!”), the user may hit the “enter” button, and the comment is posted or added to the discussion, for example, as seen in the screen shot 980 shown in FIG. 9H.

As such, the systems and methods of the present disclosure allow or enable user members to engage or participate in the community, e.g., with respect to particular content, in a more meaningful way as compared to simply leaving lightweight feedback or “liking.” By joining the discussion, members increase the social proof of that piece of content and also subscribe to receive updates on the discussion happening, such as seeing the latest messages in the associated chat room.

### Leaving or Ending a Community

Not all communities will last. For example, a community 20 organized around or relating to a music band may not survive if the band breaks up. Or some members 30 may want to quit or leave a community 20, for example, if they lose interest. In some cases, it may be desirable to expel, dismiss, or ban one or more members 30 from a community 20 if such members violate the community's policies or principles. Thus, systems and methods of the present disclosure provide or support the termination or ending of a member's relationship with an NFT-gated community 20, or in some example, the termination or ending of an entire community itself.

In contrast to conventional, previously developed systems and methods for social networking, with ecosystem 10 members 30 of a community 20, and the communities 20 themselves, are empowered to control their own content, including deleting the content and their on-line presence. This is in furtherance of the goal of a fully decentralized protocol and system, where the members and the communities—and not a social media platform provider—makes the decisions and exercises control.

In some embodiments, systems and methods of the present disclosure allow or enable each user or member to delete her/his/their content, but not the content of other users or members.

Deleting a Message: In the virtual space for each NFT-gated community 20, members can have private or one-to-one discussions with other members, for example, by exchanging messages. In some embodiments, each member or user is able to delete any of the messages that she/he/they send or receive from another member or user. This may apply for both data messages and comments. In some embodiments, when a user or member 30 deletes a message, the systems and methods will remove, delete, or erase any electronic copy or record of the message from the one or more servers in the system, so that everyone else that visits that conversation will not be able to see or view the message anymore. In some embodiments, the systems and methods will provide or allow for an indication to be made (e.g., a breadcrumb) that the message was deleted.

In some embodiments, the application 50 provides or supports a user interface on a user device 60 for deleting a message. In response to input or selection from the member 30, the application 50 presents the message to be deleted, for example in a chat bubble. The application 50 on device 60 detects whether the user has made a long press (e.g., pressing the bubble for a predetermined period of time), and if so, will present or display to the user an option to delete or erase such message, for example, as a pop up.

Deleting a Post: In the virtual space for a token-gated community 20, a member 30 can create or generate a post that is shared with or can be seen by all other members. The author owns the post because she/he/they created it, but the same author did not (necessarily) create all the comments within the discussion relating to the post. It may be desirable for community discussions relating to a post to be long-lived conversations-basically chat rooms that users or members can keep coming back to. In such cases, it may be preferable to preserve at least some portion of the discussion, e.g., the comments, even if the member who originally made the post would like to delete the post. That is, it would unjust or unfair for the post author to be able to delete a conversation other members were having in connection with the post.

Thus, in some embodiments, the systems and methods of the present disclosure allow a member to delete any post that she/he/they originally made, which causes any electronic copy or record of the post itself to be deleted or removed off of the computer servers and media storage, e.g., as shown and described with reference to FIG. 2. The deleted post is orphaned for everyone else. However, the systems and methods may provide a grace period (e.g., a week) to allow members making comments to the post to back up, save, or restore their comments in the computer servers and storage. Every community member 30 who has joined the conversation for the deleted post can still see all the messages that were in it, but they cannot see the original post anymore (as that has been deleted).

In some embodiments, when a post has been deleted, the systems and methods do not allow any new comments to be made. Basically, the remaining comments are just an archive of the conversation or discussion that some members had. Furthermore, the remaining conversation or discussion is only visible to the members that were already in it; it is not discoverable viewable by others (e.g., new members to the community). Existing participants to the conversation or discussion can leave, but no new people can join.

In some embodiments, the application 50 provides or supports a user interface on a user device 60 for deleting a post. In response to input or selection from a member 30 deleting the her/his/their post, the post is removed or deleted in the virtual space and replaced with a shaded or greyed out area so that some context for the discussion is preserved.

In some embodiments, within a community 20, if the content is deemed as inappropriate, the member 30, may report a post. In such cases, the club/community owner will be able to review reported posts, and choose to remove the post from their community.

In some embodiments, through the utilization of application programming interfaces which connect graphical user interface libraries and training sets to identify inappropriate or abusive images and automatically remove them from the community. In some instances, the user who posted the abusive image and the club owner of the community in which the abusive post was found, may receive a notification of the removed post.

Deleting a Club or Community: In some instances, it may become desirable to dissolve, disband, or delete an entire club or community 20. For example, if a community is created for a particular fund-raising event, such as collecting donations for relief of a specific disaster (e.g., earthquake, hurricane, flood, or fire), and that event is concluded, then it may be desirable to delete that community.

In some embodiments, a community 20 may be deleted or disbanded by vote of its members. In some examples, systems and methods of the present disclosure may accomplish this using one or more smart contracts, e.g., that are set up at the creation of the community. Thus, one or more members may initiate a vote for deleting the community 20, and if a predetermined number or percentage of members 30 vote in favor of deleting the community 20, then the systems and methods will do so. Thereafter, the on-line or virtual space for the community 20 will be closed and no longer accessible by anyone. In some embodiments, all users who own or have been assigned non-fungible tokens 40 for the deleted community maintain or keep those tokens; such tokens are not automatically deleted even when the related community to which the tokens gave access has been disbanded.

As previously discussed, since existing posts in the community's on-line space were created by their member authors and not the community as a whole, in some embodiments, such posts are not be automatically deleted even when the community itself is deleted or disbanded. This is in keeping with giving user members control over their content. The original member authors of the posts are given the choice or right to decide what happens to the posts. Thus, upon deletion of a community, if a member author has not already elected to delete the posts that she/he/they created, the posts will be kept or remain, e.g., in the ecosystem 10, but will be “orphaned.” The systems and methods will not allow any new messages or comments to be made to the post. Only people who had joined the discussion or conversation for the post prior to deletion of the community can view the post. The original post is still visible to the people who have joined that conversation, but the user interface displays or indicates that the club in which it was posted has been deleted.

Even after a community has been deleted, the smart contracts for the community will continue to be deployed or exist, e.g., in the blockchain. In some embodiments, systems and methods of the present disclosure will warn users or members that any smart contracts generated or created for a community cannot be taken back, even after club deletion. In some embodiments, upon deletion of a community 20, systems and methods of the present disclosure will notify some or all members 30 of the orphaned smart contracts.

In a decentralized setting, such as the case with a DAO structure for one or more communities 20, it is preferable that no one person or user be given the right to delete a whole group or community—that defeats the point of decentralization. Nonetheless, there may be instances where it is desirable that a single user be given the ability to delete a community 20.

In some embodiments, systems and methods of the present disclosure provide or support processes, procedures, interfaces for allowing or enabling a single user (such as a high level officer or founding member) to delete a community 20. In some examples, when the user initiates the process for deleting a community, the systems and methods query or ask the user to confirm her/his/their identity, and as a further check, ask or require the user to log in again. The user is asked or queried to confirm that she/he/they actually want to delete the community, and the systems and methods notify or present the user with the implications—e.g., the on-line space for the community will be closed, all content will be archived, one or more smart contracts may be orphaned, etc. The systems and methods will present the user with an interface with a final “delete” option (e.g., button or active icon), and upon activation will run or perform the processes and operations for deletion (e.g., cleaning up or archiving posts).

Deleting an Account: In some instances, an existing member of a community 20 may desire to leave the community, for example, over differences in opinion, focus, vision, etc. In some examples, a user may effectively leave the community by deleting her/his/their membership account with the community.

In some embodiments, the process or procedure for deleting an account can be similar in some aspects to that for deleting a community. The system and methods may query or ask the user member to confirm her/his/their identity, and then require the user to log in again. Then the system and method query or ask the user to confirm that she/he/they actually want to delete the account. Upon confirmation, the systems and methods notify or present the user with the implications of deleting the member account—e.g., some or all of her/his/their posts will be deleted and the conversations archived. The systems and methods will present the user with an interface with a final “delete” option (e.g., button or active icon), and upon activation will run or perform the processes and operations for deletion of the account.

In some embodiments, when a member user deletes her/his/their account, systems and methods of the present disclosure may ask or query the user whether she/he/they would like to have any or all of her/his/their posts, comments, and other contributed content deleted or removed. Again, this is in keeping with giving user members of the communities 20 control over their content.

If a user member has indicated to the system that she/he/they are deleting her/his/their membership account, the system may provide an interface displaying an itemized list of all content, posts, comments contributed to the community by that user. For each item, the system allows the user to enter an indication or election as to whether the content item should be deleted. Any item that the user elects to be deleted will be removed from the on-line space for the community 20. However, the content, posts, comments contributed by other members are not deleted. In some embodiments, conversations or discussions with content from the deleting member are archived, and no further comments are allowed. Any other member wishing to view the conversations or discussions are provided with a display or interface indicating that conversation has been archived.

In some embodiments, when a member 30 leaves a club or community 20, the systems and methods of the present disclosure queue an asynchronous job and run the job to remove the member from the club or community's smart contract. The user's wallet address is dispatched via the NEAR RPC protocol and invokes the nft_burn function.

The descriptions above disclose various example systems, methods, apparatus, and articles of manufacture including, among other components, firmware and/or software executed on hardware. However, such examples are merely illustrative and should not be considered as limiting. For example, it is contemplated that any or all of these firmware, hardware, and/or software components can be embodied exclusively in hardware, exclusively in software, exclusively in firmware, or in any combination of hardware, software, and/or firmware. Accordingly, while the following describes example systems, methods, apparatus, and/or articles of manufacture, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of the invention. The appearances of this phrase in various places in the present disclosure are not necessarily all referring to the same embodiment, nor are separate or alternative embodiments mutually exclusive of other embodiments. As such, the embodiments described herein, explicitly and implicitly understood by one skilled in the art, can be combined with other embodiments.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications. Thus, the scope of the present application should be limited only by the following claims, and it is appropriate that the claims be construed broadly and in a manner consistent with the scope of the embodiments disclosed herein.

What is claimed is:

1. A computer-implemented method comprising:
activating an invitation process for one or more invitations associated with an on-line community;
displaying, utilizing a first screen, a first user interface for intaking one or more parameters from a user for invitations to join the on-line community;
receiving one or more parameters input by the user for inviting at least one person to join the on-line community as a member;
based at least in part on the received one or more parameters, generating a hyperlink for the at least one person to be invited to join on-line community as a member;
automatically embedding the hyperlink in an electronic invitation; and
transmitting over a network the electronic invitation with embedded hyperlink to the at least one person to be invited to join on-line community as a member;
wherein if the at least one person clicks on the hyperlink, automatically minting a non-fungible token and assigning the non-fungible token to the at least one person, wherein the assigned non-fungible token allows the at least one person to access to the on-line community through an application running on a user device.

2. The method of claim 1 wherein the non-fungible token comprises a membership card.

3. The method of claim 1 comprising displaying, utilizing a second screen, a second user interface for intaking one or more parameters from the at least one person to generate the membership card.

4. The method of claim 2 wherein the non-fungible token is supported with a blockchain.

5. The method of claim 4 wherein the blockchain implements the NEAR blockchain protocol.

7. The method of claim 1 comprising adding the minted non-fungible token to a digital wallet for the least one person invited to join on-line community as a member.

8. The method of claim 1 comprising authenticating the least one person invited to join on-line community as a member.

9. The method of claim 1 wherein the on-line community is associated with a decentralized autonomous organization (DAO).

10. A non-transitory computer-readable medium comprising instructions that, when executed by one or more processors, are configured to:
activate an invitation process for one or more invitations associated with an on-line community;
display, utilizing a first screen, a first user interface for intaking one or more parameters from a user for invitations to join the on-line community;
receive one or more parameters input by the user for inviting at least one person to join the on-line community as a member;
based at least in part on the received one or more parameters, generate a hyperlink for the at least one person to be invited to join on-line community as a member;
automatically embed the hyperlink in an electronic invitation; and
transmit over a network the electronic invitation with embedded hyperlink to the at least one person to be invited to join on-line community as a member;
wherein if the at least one person clicks on the hyperlink, automatically mint a non-fungible token and assigning the non-fungible token to the at least one person, wherein the assigned non-fungible token allows the at least one person to access to the on-line community through an application running on a user device.

11. The medium of claim 10 wherein the non-fungible token comprises a membership card.

12. The medium of claim 11 comprising instructions configured to display, utilizing a second screen, a second user interface for intaking one or more parameters from the at least one person to generate the membership card.

13. The medium of claim 11 wherein the non-fungible token is supported with a blockchain.

14. The medium of claim 13 wherein the blockchain implements the NEAR blockchain protocol.

15. The medium of claim 10 comprising instructions configured to add the minted non-fungible token to a digital wallet for the least one person invited to join on-line community as a member.

16. The medium of claim 10 comprising instructions configured to authenticate the least one person invited to join on-line community as a member.

17. The medium of claim 10 wherein the on-line community is associated with a decentralized autonomous organization (DAO).

18. A system comprising:
at least one non-transitory memory storing instructions; and
one or more processors in communication with the at least one non-transitory memory, wherein the one or more processors execute the instructions to cause the system to:
activate an invitation process for one or more invitations associated with an on-line community;
display, utilizing a screen, a user interface for intaking one or more parameters from a user for invitations to join the on-line community;
receive one or more parameters input by the user for inviting at least one person to join the on-line community as a member;
based at least in part on the received one or more parameters, generate a hyperlink for the at least one person to be invited to join on-line community as a member;
automatically embed the hyperlink in an electronic invitation; and
transmit over a network the electronic invitation with embedded hyperlink to the at least one person to be invited to join on-line community as a member;
wherein if the at least one person clicks on the hyperlink, automatically mint a non-fungible token and assigning the non-fungible token to the at least one person, wherein the assigned non-fungible token allows the at least one person to access to the on-line community through an application running on a user device.

19. The system of claim 18 wherein the non-fungible token comprises a membership card.

20. The system of claim 19 wherein the non-fungible token is supported with a blockchain.

21. The system of claim 20 wherein the blockchain implements the NEAR blockchain protocol.

22. The system of claim 18 wherein the one or more processors execute the instructions to cause the system to add the minted non-fungible token to a digital wallet for the least one person invited to join on-line community as a member.

23. The system of claim 18 wherein the one or more processors execute the instructions to cause the system to authenticate the least one person invited to join on-line community as a member.
